(19) United States
(12) Patent Application Publication
(10) Pub. No.: US 2025/0200057 A1
(43) Pub. Date: Jun. 19, 2025

(54) FOUNDATION MACHINE LEARNING MODELS FOR SENSORY OR OTHER TIME-SERIES DATA

(71) Applicant: C3.ai, Inc., Redwood City, CA (US)

(72) Inventors: Sina K. Pakazad, Redwood City, CA (US); Henrik Ohlsson, Menlo Park, CA (US); Utsav Dutta, Mountain View, CA (US)

(21) Appl. No.: 18/981,087

(22) Filed: Dec. 13, 2024

Related U.S. Application Data
(60) Provisional application No. 63/610,285, filed on Dec. 14, 2023.

(51) Int. Cl. G06F 16/2458; G06F 16/22; G06N 3/045; G06N 3/0475; G06N 3/094; G06N 3/096

(52) U.S. Cl. CPC G06F 16/2477; G06F 16/2237; G06N 3/045; G06N 3/0475; G06N 3/094; G06N 3/096

(57) ABSTRACT

A method includes obtaining time-series data of at least one type and at least one textual description of the at least one type of time-series data and processing the time-series data and the at least one textual description using a foundation machine learning model. Processing the time-series data and the at least one textual description using the foundation machine learning model includes generating at least one embedding of the at least one textual description, combining the time-series data and the at least one embedding of the at least one textual description to generate combined data, and generating embedding vectors using the combined data.

### CROSS-REFERENCE TO RELATED APPLICATION AND PRIORITY CLAIM

This application claims priority under 35 U.S.C. § 119 (e) to U.S. Provisional Patent Application No. 63/610,285 filed on Dec. 14, 2023, which is hereby incorporated by reference in its entirety.

### TECHNICAL FIELD

This disclosure is generally directed to machine learning systems and processes. More specifically, this disclosure is directed to foundation machine learning models for sensory or other time-series data.

### BACKGROUND

Machine learning models have been used in various machine learning pipelines to support and serve various downstream processes. For example, a platform may allow a user to define a data pipeline using the platform's graphical user interface, where the graphical user interface allows the user to define the operations to be performed by the data pipeline. At least one of the operations of the data pipeline can be performed by or using at least one machine learning model. After training, the machine learning model(s) can be placed into use in order to process data in the data pipeline and generate predictions or other outputs using the processed data.

### SUMMARY

This disclosure relates to foundation machine learning models for sensory or other time-series data.

In a first embodiment, a method includes obtaining time-series data of at least one type and at least one textual description of the at least one type of time-series data and processing the time-series data and the at least one textual description using a foundation machine learning model. Processing the time-series data and the at least one textual description using the foundation machine learning model includes generating at least one embedding of the at least one textual description, combining the time-series data and the at least one embedding of the at least one textual description to generate combined data, and generating embedding vectors using the combined data.

Any one or any combination of the following features may be used with the first embodiment.

Combining the time-series data and the at least one embedding of the at least one textual description may include combining the time-series data, the at least one embedding of the at least one textual description, and at least one positional embedding to generate the combined data. The at least one positional embedding may define relative positions of different data values of the time-series data in time. Combining the time-series data, the at least one embedding of the at least one textual description, and the at least one positional embedding may include concatenating the time-series data, the at least one embedding of the at least one textual description, and the at least one positional embedding.

The method may include generating a prediction associated with the time-series data using the embedding vectors. The embedding vectors may be generated using an encoder of the foundation machine learning model, and the prediction may be generated using a decoder.

The method may include using the embedding vectors to identify at least one time point associated with historical time-series data and obtaining additional information associated with the at least one time point.

Generating the at least one embedding of the at least one textual description may include generating the at least one embedding of the at least one textual description using a language embedding model of the foundation machine learning model.

The time-series data may relate to a specified asset in a specified asset class. The foundation machine learning model may be trained using training data associated with the specified asset class but not training data associated with the specified asset.

The method may include providing the embedding vectors to at least one task head and performing one or more tasks using the at least one task head. The one or more tasks may include at least one of: generation of specialized embeddings, classification, forecasting, anomaly detection, or imputation.

The time-series data may be divided into multiple time slices including a specified time slice and additional time slices, and embedding vectors may be generated for each of the time slices. The method may include identifying one or more of the additional time slices that are most similar to the specified time slice based on the embedding vectors, obtaining a user query associated with the specified time slice, and generating a response to the user query based on the one or more additional time slices that are most similar to the specified time slice. The specified time slice may be associated with a time period during which values of the time-series data were previously predicted. The user query may be related to a divergence of actual values of the time-series data from predicted values of the time-series data within the specified time slice. The response may identify at least one explanation for the divergence based on the one or more additional time slices that are most similar to the specified time slice.

Combining the time-series data and the at least one embedding of the at least one textual description may include using different permutations in ordering the time-series data.

In a second embodiment, a method includes training a foundation machine learning model to process time-series data of at least one type and textual descriptions of the time-series data and generate embedding vectors associated with the time-series data. Training the foundation machine learning model includes training a language embedding model to generate embeddings of the textual descriptions of the time-series data and training an encoder to generate the embedding vectors using combinations of the time-series data and the embeddings of the textual descriptions.

Any one or any combination of the following features may be used with the second embodiment.

The encoder may be trained to generate the embedding vectors using combinations of the embeddings of the textual descriptions, the embeddings of the time-series data, and at least one positional embedding. The at least one positional embedding may define relative positions of different data values of the time-series data in time. The foundation machine learning model may concatenate the time-series data, the embeddings of the textual descriptions, and the at least one positional embedding.

The method may include training the foundation machine learning model or another model to generate a prediction associated with the time-series data using the embedding vectors.

The time-series data may represent training data related to multiple assets in a specified asset class. The foundation machine learning model may be trained to generate embedding vectors for additional time-series data associated with a specified asset, where the training data lacks data for the specified asset.

The method may include training at least one task head to perform one or more tasks using the embedding vectors. The one or more tasks may include at least one of: generation of specialized embeddings, classification, forecasting, anomaly detection, or imputation.

Training the foundation machine learning model may include using different permutations in an order of the time-series data.

The method may include training a decoder to generate predictions using the embedding vectors.

Training the foundation machine learning model may include using a contrastive loss associated with the embeddings of the time-series data.

In a third embodiment, a method includes providing time-series data of at least one type and at least one textual description of the at least one type of time-series data to a foundation machine learning model. The method also includes receiving a prediction based on embedding vectors generated by the foundation machine learning model using the time-series data and the at least one textual description. The foundation machine learning model is configured to process the time-series data and the at least one textual description by generating at least one embedding of the at least one textual description, combining the time-series data and the at least one embedding of the at least one textual description to generate combined data, and generating the embedding vectors using the combined data.

Any one or any combination of the following features may be used with the third embodiment.

The method may include identifying at least one positional embedding to the foundation machine learning model. The at least one positional embedding may define relative positions of different data values of the time-series data in time.

The prediction associated with the time-series data may be generated by the foundation machine learning model based on the embedding vectors.

The prediction may be received from a second machine learning model. The second machine learning model may be configured to generate the prediction based on the embedding vectors.

The time-series data may relate to a specified asset in a specified asset class. The foundation machine learning model may be trained using training data associated with the specified asset class but not training data associated with the specified asset.

The time-series data may be divided into multiple time slices including a specified time slice and additional time slices. The foundation machine learning model may be configured to generate embedding vectors for each of the time slices. The method may include providing a user query associated with the specified time slice and receiving a response to the user query based on one or more additional time slices that are most similar to the specified time slice based on the embedding vectors. The specified time slice may be associated with a time period during which values of the time-series data were previously predicted. The user query may be related to a divergence of actual values of the time-series data from predicted values of the time-series data within the specified time slice. The response may identify at least one explanation for the divergence based on the one or more additional time slices that are most similar to the specified time slice.

In a fourth embodiment, a method includes obtaining time-series data associated with multiple sensors and multiple textual descriptions of the time-series data. The method also includes processing the time-series data and the textual descriptions using a foundation machine learning model. Processing the time-series data and the textual descriptions using the foundation machine learning model includes generating textual embeddings of the textual descriptions, modeling the time-series data using a temporal convolutional network, and processing the modeled time-series data and the textual embeddings of the textual descriptions using multiple contextual attention layers. Each contextual attention layer is configured to selectively provide controllable attention across different ones of the sensors and across different times or time periods.

Any one or any combination of the following features may be used with the fourth embodiment.

The method may include mixing the textual embeddings of the textual descriptions to generate mixed textual description embeddings. Processing the modeled time-series data and the textual embeddings may include processing the modeled time-series data and the mixed textual description embeddings. At least one of the contextual attention layers may be configured to generate query, key, and value matrices based on the modeled time-series data and reshape and project the mixed textual description embeddings based on dimensions of the query, key, and value matrices.

Each of the contextual attention layers may be trained to determine how to provide, for a specified one of the sensors, more or less attention to one or more other sensors during the processing the time-series data and the textual descriptions and determine how to provide, for the specified one of the sensors at a given time or time period, more or less attention to one or more other time periods during the processing the time-series data and the textual descriptions. Each of the contextual attention layers may be trained to process query, key, and value matrices while providing attention based on the determinations how to provide more or less attention in order to provide the controllable attention across the different ones of the sensors and across the different times or time periods.

The method may include generating a prediction using the foundation machine learning model based on the time-series data and the textual descriptions.

The method may include using the foundation machine learning model to identify at least one time point associated with historical time-series data and obtaining additional information associated with the at least one time point.

The time-series data may relate to a specified asset in a specified asset class. The foundation machine learning model may be trained using training data associated with the specified asset class but not training data associated with the specified asset.

The method may include providing embedding vectors from the foundation machine learning model to at least one task head and performing one or more tasks using the at least one task head. The one or more tasks may include at least one of: generation of specialized embeddings, classification, forecasting, anomaly detection, or imputation.

The time-series data may be divided into multiple time slices including a specified time slice and additional time slices. The method may include identifying one or more of the additional time slices that are most similar to the specified time slice, obtaining a user query associated with the specified time slice, and generating a response to the user query based on the one or more additional time slices that are most similar to the specified time slice. The specified time slice may be associated with a time period during which values of the time-series data were previously predicted. The user query may be related to a divergence of actual values of the time-series data from predicted values of the time-series data within the specified time slice. The response may identify at least one explanation for the divergence based on the one or more additional time slices that are most similar to the specified time slice.

In a fifth embodiment, a method includes training a foundation machine learning model to process time-series data associated with multiple sensors and multiple textual descriptions of the time-series data. Training the foundation machine learning model includes obtaining a training dataset including training time-series data and training textual descriptions of the training time-series data and perturbing the training time-series data to generate corrupted training time-series data. Training the foundation machine learning model also includes generating first outputs based on the training time-series data and the training textual descriptions using a teacher machine learning model and generating second outputs based on the corrupted training time-series data and the training textual descriptions using a student machine learning model. Training the foundation machine learning model further includes adjusting weights of the teacher machine learning model and weights of the student machine learning model based on the first and second outputs. The weights of the student machine learning model are adjusted in a different manner than the weights of the teacher machine learning model. The student machine learning model represents the foundation machine learning model being trained.

Any one or any combination of the following features may be used with the fifth embodiment.

The weights of the student machine learning model may be adjusted based on the first and second outputs. The weights of the teacher machine learning model may be calculated as exponential moving averages of the weights of the student embedding model.

Perturbing the training time-series data to generate the corrupted training time-series data may include randomly creating missing values and outlier values in the training time-series data.

The method may include training the foundation machine learning model or another model to generate a prediction using embedding vectors generated by the student machine learning model.

The training time-series data may be related to multiple assets in a specified asset class. The foundation machine learning model may be trained to generate embedding vectors for additional time-series data associated with a specified asset, the training time-series data lacking data for the specified asset.

The method may include training at least one task head to perform one or more tasks using embedding vectors generated by the student machine learning model. The one or more tasks may include at least one of: generation of specialized embeddings, classification, forecasting, anomaly detection, or imputation.

Training the foundation machine learning model may include generating textual embeddings of the training textual descriptions and mixing the textual embeddings of the textual descriptions to generate mixed textual description embeddings.

Training the foundation machine learning model may include using a contrastive loss associated with the first and second outputs.

In a sixth embodiment, a method includes providing time-series data associated with multiple sensors and at least one textual description of the time-series data to a foundation machine learning model. The method also includes receiving a prediction based on at least one output generated by the foundation machine learning model using the time-series data and the at least one textual description. The foundation machine learning model is configured to process the time-series data and the at least one textual description by generating textual embeddings of the textual descriptions, modeling the time-series data using a temporal convolutional network, and processing the modeled time-series data and the textual embeddings of the textual descriptions using multiple contextual attention layers. Each contextual attention layer is configured to selectively provide controllable attention across different ones of the sensors and across different times or time periods.

Any one or any combination of the following features may be used with the sixth embodiment.

The foundation machine learning model may be configured to process the time-series data and the at least one textual description by mixing the textual embeddings of the textual descriptions to generate mixed textual description embeddings. The foundation machine learning model may be configured to process the modeled time-series data and the mixed textual description embeddings. At least one of the contextual attention layers may be configured to generate query, key, and value matrices based on the modeled time-series data and reshape and project the mixed textual description embeddings based on dimensions of the query, key, and value matrices.

Each of the contextual attention layers may be trained to determine how to provide, for a specified one of the sensors, more or less attention to one or more other sensors during the processing the time-series data and the textual descriptions and determine how to provide, for the specified one of the sensors at a given time or time period, more or less attention to one or more other time periods during the processing the time-series data and the textual descriptions. Each of the contextual attention layers may be trained to process query, key, and value matrices while providing attention based on the determinations how to provide more or less attention in order to provide the controllable attention across the different ones of the sensors and across the different times or time periods.

The prediction may be received from a second machine learning model. The second machine learning model may be configured to generate the prediction based on embedding vectors generated by the foundation machine learning model.

The time-series data may relate to a specified asset in a specified asset class. The foundation machine learning model may be trained using training data associated with the specified asset class but not training data associated with the specified asset.

The time-series data may be divided into multiple time slices including a specified time slice and additional time slices. The foundation machine learning model may be configured to generate embedding vectors for each of the time slices. The method may include providing a user query associated with the specified time slice and receiving a response to the user query based on one or more additional time slices that are most similar to the specified time slice based on the embedding vectors. The specified time slice may be associated with a time period during which values of the time-series data were previously predicted. The user query may be related to a divergence of actual values of the time-series data from predicted values of the time-series data within the specified time slice. The response may identify at least one explanation for the divergence based on the one or more additional time slices that are most similar to the specified time slice.

An apparatus may include at least one processing device configured to perform one, some, or all of the methods of the first through sixth embodiments (optionally along with one or any combination of the described features of any of the first through sixth embodiments).

A non-transitory machine readable medium containing instructions that when executed cause at least one processor to perform one, some, or all of the methods of the first through sixth embodiments (optionally along with one or any combination of the described features of any of the first through sixth embodiments).

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting foundation machine learning models for sensory or other time-series data according to this disclosure;

FIG. 2 illustrates an example device supporting foundation machine learning models for sensory or other time-series data according to this disclosure;

FIGS. 3A and 3B illustrate an example foundation machine learning model for sensory or other time-series data according to this disclosure;

FIG. 4 illustrates an example method for training foundation machine learning models for sensory or other time-series data according to this disclosure;

FIG. 5 illustrates an example method for using foundation machine learning models for sensory or other time-series data according to this disclosure;

FIGS. 6 through 8 illustrate example pipelines using foundation machine learning models for sensory or other time-series data to support specified functions according to this disclosure;

FIG. 9 illustrates another example foundation machine learning model for sensory or other time-series data according to this disclosure; and

FIG. 10 illustrates an example training process for the foundation machine learning model for sensory or other time-series data of FIG. 9 according to this disclosure.

### DETAILED DESCRIPTION

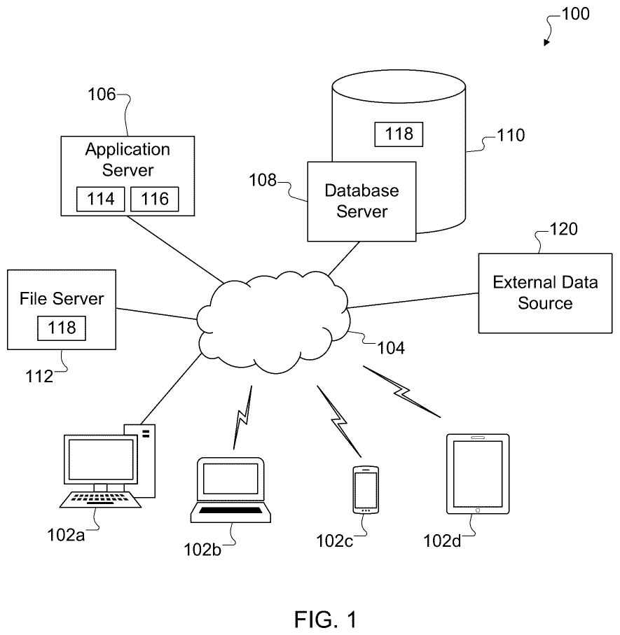

FIGS. 1 through 10, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, machine learning models have been used in various machine learning pipelines to support and serve various downstream processes. For example, a platform may allow a user to define a data pipeline using the platform's graphical user interface, where the graphical user interface allows the user to define the operations to be performed by the data pipeline. At least one of the operations of the data pipeline can be performed by or using at least one machine learning model. After training, the machine learning model(s) can be placed into use in order to process data in the data pipeline and generate predictions or other outputs using the processed data.

While these machine learning pipelines can be effective, there can be various limitations associated with the machine learning pipelines and their associated development processes. For example, development of certain operations in the machine learning pipelines can be very time-consuming and labor-intensive, which can limit the scalability and ease of deployment of these pipelines. Moreover, it can often be difficult to deal with different modalities of data, such as when attempting to combine language, vision, and sensory data for use by a machine learning model. In addition, the structures of the machine learning models and the ways in which they are trained commonly expose spurious correlations in order to produce better-quality predictions. However, this can adversely affect the interpretability or explainability of the results generated by the machine learning models, which can reduce their effectiveness in supporting decision-making processes or other processes. Often times, there is typically a trade-off between a machine learning model's interpretability and its complexity or representational power. Some attempts to strike a better trade-off between model interpretability and model performance can augment insights from interpretability with subject matter expert knowledge, such as in the form of rules and heuristics. Unfortunately, this is very labor-intensive, which again can limit the scalability and ease of deployment of these pipelines.

Over the past several years, there have been various improvements in better understanding underlying processes governing several key modalities of data, namely language, vision, and acoustics. These developments have been powered by foundation machine learning models for these modalities, where these foundation models are trained to uncover informative representations for these modalities. The informative representations are also known as embeddings and are often packed with information. The foundation models developed for generating these embeddings have been used directly for their emerging zero-shot capabilities and for developing other models for specific tasks, such as by using the foundation models' embeddings as features powering other models or by directly fine-tuning these foundation models with additional heads. The foundation models have also been combined to create multi-modal foundation models in various ways, such as by combining different modalities to enable multi-modal representations via fusion, coordination, or fission.

These foundation models are often developed using large amounts of data and using different training processes. For instance, some foundation models have been trained directly in an unsupervised or self-supervised fashion, such as through masking of data and learning how to fill in the blanks. Other foundation models have been trained by going through an extra training step based on contrastive losses or weak supervision to help ensure that learned embeddings are packed with relevant discriminative information. Similar approaches and training processes have been used for creating multi-modal foundation models in a fusion setting. Despite this progress, foundation models for sensory or other time-series data have not been thoroughly examined or developed. This may be due to various factors, such as a lack of sufficient data and processes to enable combining sensory or other time-series data from different sources and use cases.

This disclosure provides various techniques related to foundation machine learning models for sensory or other time-series data. As described in more detail below, a foundation machine learning model for sensory or other time-series data can be designed to process time-series data while accounting for different sources and use cases. For example, time-series data and textual descriptions of the time-series data can be obtained by a foundation machine learning model. The textual descriptions of the time-series data can be processed using a language embedding model to generate embeddings of the textual descriptions, and the time-series data can be combined with the textual description embeddings. The time-series data may also be combined with positional embeddings, which may be used to define relative positions of different time-series datasets or data values in time. The time-series data with the textual description embeddings and the positional embeddings can be processed by the foundation machine learning model in order to generate embedding vectors associated with the time-series data, such as by processing the time-series data with the embeddings by an encoder of the foundation machine learning model. The embedding vectors may be processed or used in any suitable manner by the foundation machine learning model, such as when the embedding vectors are processed using a decoder of the foundation machine learning model in order to generate predictions related to the time-series data. Various techniques for training foundation machine learning models are described below, and various larger architectures that can incorporate one or more trained foundation machine learning model are also described below.

In this way, it is possible to mix time-series data from different fields or domains since the textual description embeddings and the positional embeddings can provide context used by the foundation machine learning models to differentiate among the time-series data. As a result, the described foundation models can be trained to easily handle different modalities of time-series data. Also, by having the textual description embeddings available, it is possible to reduce or remove the sensitivity of the foundation machine learning models to the ordering of the time-series data. That is, the foundation machine learning models can be trained to generate the same or substantially similar predictions regardless of how the time-series data is ordered. In some cases, this may be achieved by augmenting training datasets with different permutations in the ordering of the time-series data. Moreover, training a foundation machine learning model that provides a good internal representation of time-series data can help to overhaul and simplify the process for developing machine learning pipelines, which can decrease the time and labor needed to develop the pipelines and increase the scalability and ease of deployment of the pipelines. Further, the foundation machine learning models can be used to support improved interpretability or explainability of the results generated by the machine learning models. Various additional advantages or benefits may be obtained depending on the implementation, such as improved performance of the foundation machine learning models with reduced amounts of input data, more effective and direct usage of metadata and log data by the foundation machine learning models, reduced or removed need for using labeled training data, creation of more standardized and uniform training processes irrespective of use case, incorporation of better approaches for improving the foundation machine learning models and the associated pipelines based on user feedback, and reduced or removed need for performing feature engineering.

FIG. 1 illustrates an example system 100 supporting foundation machine learning models for sensory or other time-series data according to this disclosure. As shown in FIG. 1, the system 100 includes one or more user devices 102a-102d, one or more networks 104, one or more application servers 106, and one or more database servers 108 associated with one or more databases 110 and/or one or more file servers 112. Each user device 102a-102d communicates over the network 104, such as via a wired or wireless connection. Each user device 102a-102d represents any suitable device or system used by at least one user to provide or receive information, such as a desktop computer, a laptop computer, a smartphone, and a tablet computer. However, any other or additional types of user devices may be used in the system 100.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations.

The application server 106 is coupled to the network 104 and is coupled to or otherwise communicates with the database server 108 and/or file server 112. The application server 106 supports the training and/or use of foundation machine learning models for sensory or other time-series data. For example, the application server 106 may execute one or more applications 114 that train one or more foundation machine learning models 116 and/or process data using one or more foundation machine learning models 116. In some cases, the one or more foundation machine learning models 116 can be trained and/or used to process time-series data, such as time-series data 118 stored in the database 110 and/or file server 112. In some embodiments, the one or more foundation machine learning models 116 may be used in one or more data or machine learning pipelines. For instance, the one or more applications 114 may support the AI EX MACHINA platform from C3.AI, INC., which can be used to create and use data or machine learning pipelines graphically (although any other suitable platform that allows users to define or use foundation machine learning models 116 may be used here). As described below, the one or more foundation machine learning models 116 can be designed to receive and process time-series data 118 and optionally other data in order to generate predictions or other outputs associated with the time-series data 118. The predictions or other outputs may be used in any suitable manner, such as to support one or more downstream processes.

The database server 108 and/or the file server 112 operates to store and facilitate retrieval of various information used, generated, or collected by the application server 106 and the user devices 102a-102d. For example, the database server 108 and/or the file server 112 may store time-series data 118 used to train the one or more foundation machine learning models 116 and/or time-series data 118 that is processed using the one or more foundation machine learning models 116. In other embodiments, the database server 108 and/or the file server 112 may be used within the application server 106 to store information, in which case the application server 106 may store the information itself.

Note that the foundation machine learning model(s) 116 may be used here to perform various functions related to time-series data 118. For example, the foundation machine learning model(s) 116 may be used to process existing time-series data 118 in order to generate predictions about future values of the time-series data 118. Also note that the foundation machine learning model(s) 116 may be used to process any suitable time-series data 118, such as sensory data or other data collected over time and therefore having a time-based dependency. In some cases, the time-series data 118 relates to various assets, which can refer to people, vehicles, pumps or other industrial equipment, or other objects. As a particular example, time-series data 118 related to people may include health-related information, such as information collected by smart watches or other devices worn or used by people. As another particular example, time-series data 118 related to vehicles, pumps or other industrial equipment, or other objects may include temperature, pressure, or other sensor measurements.

In some embodiments, the time-series data 118 may be received from one or more user devices 102a-102d for use by the foundation machine learning model(s) 116. In other embodiments, the time-series data 118 may be received from one or more external data sources 120 for use by the foundation machine learning model(s) 116. The application server 106 may also or alternatively receive additional information (other than time-series data 118) from the one or more external data sources 120 for use by the foundation machine learning model(s) 116. In some cases, for instance, the additional information might provide additional context for the time-series data 118. As a particular example, weather-related information, finance-related information (such as stock market indices), or location information may be used by one or more foundation machine learning models 116 when analyzing health information associated with various people, since that additional information can provide one or more contexts that may help to provide explanations for changes in the people's health information.

Although FIG. 1 illustrates one example of a system 100 supporting foundation machine learning models 116 for sensory or other time-series data, various changes may be made to FIG. 1. For example, the system 100 may include any suitable number of user devices 102a-102d, networks 104, application servers 106, database servers 108, databases 110, file servers 112, applications 114, foundation machine learning models 116, time-series data 118, and external data sources 120. Also, these components may be located in any suitable locations and might be distributed over a large area. In addition, while FIG. 1 illustrates one example operational environment in which foundation machine learning models 116 for sensory or other time-series data may be trained and/or used, this functionality may be used in any other suitable system.

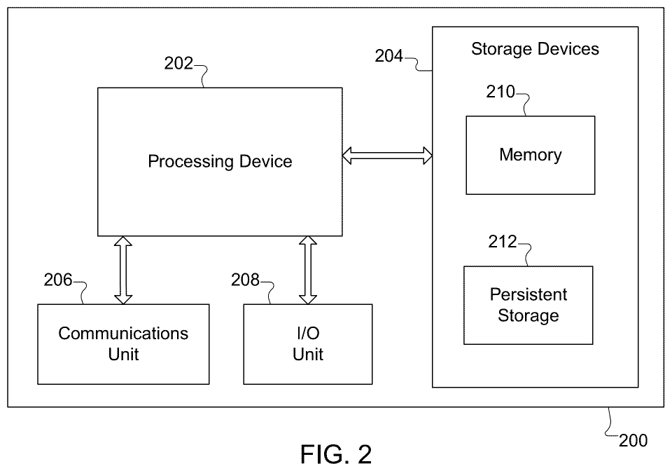

FIG. 2 illustrates an example device 200 supporting foundation machine learning models 116 for sensory or other time-series data 118 according to this disclosure. For example, one or more instances of the device 200 may be used to at least partially implement the functionality of the application server 106 in the system 100 of FIG. 1. As other examples, one or more instances of the device 200 may be used to at least partially implement the functionality of each of the user devices 102a-102d, database server 108, or file server 112 of FIG. 1. However, the functionality of the application server 106 or other components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application-specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over at least one physical or wireless network, such as the network 104. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement the functionality of the one or more applications 114. Thus, for example, the instructions when executed by the processing device 202 may cause the device 200 to obtain and process time-series data 118 using one or more foundation machine learning models 116. The instructions when executed by the processing device 202 may also or alternatively cause the device 200 to obtain training data and train one or more foundation machine learning models 116.

Although FIG. 2 illustrates one example of a device 200 supporting foundation machine learning models 116 for sensory or other time-series data 118, various changes may be made to FIG. 2. For example, computing and communication devices and systems come in a wide variety of configurations, and FIG. 2 does not limit this disclosure to any particular computing or communication device or system.

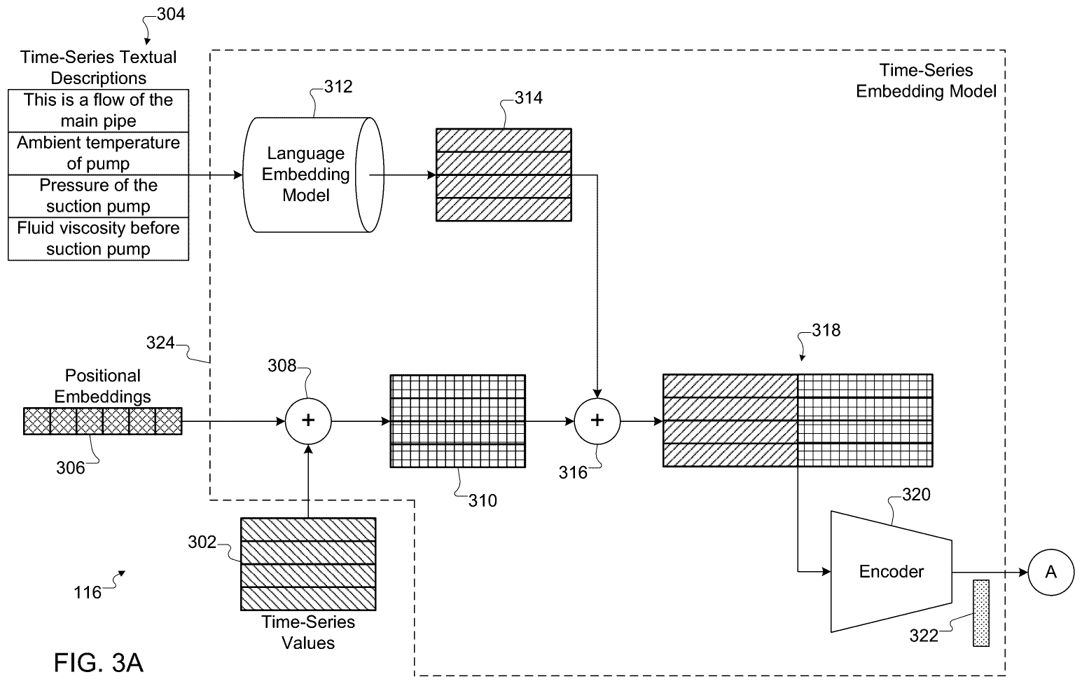

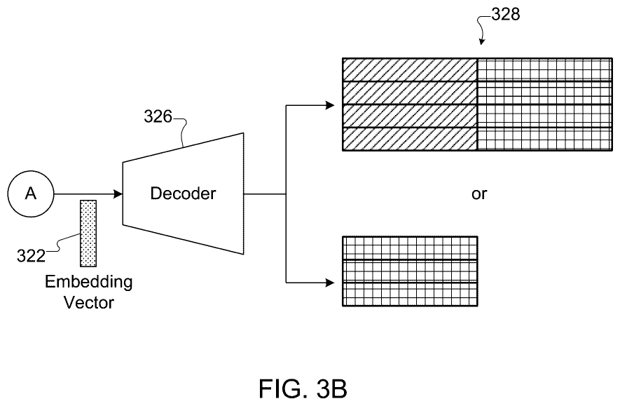

FIGS. 3A and 3B illustrate an example foundation machine learning model 116 for sensory or other time-series data 118 according to this disclosure. For ease of explanation, the foundation machine learning model 116 shown in FIGS. 3A and 3B is described as being used in the system 100 of FIG. 1, such as when the foundation machine learning model 116 is trained and/or used by the application server 106 (which may be implemented using one or more instances of the device 200 shown in FIG. 2). However, the foundation machine learning model 116 shown in FIGS. 3A and 3B may be used by or with any suitable device(s) and in any suitable system(s).

As shown in FIGS. 3A and 3B, the foundation machine learning model 116 generally operates to receive and process time-series data 118, which in this example takes the form of a collection of time-series data values 302. In some cases, the time-series data values 302 may be arranged in rows, where each row represents a set of data values from or otherwise associated with a single sensor or other source and where different rows represent different sets of data values from or otherwise associated with different sensors or other sources. Note that the time-series data values 302 here may represent actual time-series values or embeddings representing the actual time-series values. Also note that the time-series data values 302 can undergo any desired pre-processing prior to being provided to the foundation machine learning model 116. For instance, pre-processing may be performed to filter the time-series data values 302 (such as by removing outliers from the time-series data values 302) or to fill in missing time-series data values 302 (such as by performing interpolation of missing time-series data values 302 using obtained time-series data values 302).

The foundation machine learning model 116 also generally operates to receive and process textual descriptions 304 of the time-series data values 302. Each textual description 304 represents a natural language description or other text-based description of at least part of the time-series data values 302. For example, each textual description 304 can represent a text-based description of what at least some of the time-series data values 302 represent. In this particular example, for instance, the time-series data values 302 relate to different sensor measurements associated with a pump, and the textual descriptions 304 generally describe what characteristics those different sensor measurements represent with respect to the pump. However, this is for illustration and explanation only. Each textual description 304 may include any suitable description of time-series data, such as a description using functional language or descriptive language. In some cases, each row of time-series data values 302 may be associated with a specific sensor or other data source as noted above, and each row of the textual descriptions 304 may include a description of the corresponding row of time-series data values 302.

The foundation machine learning model 116 may further optionally receive and process positional embeddings 306. As noted above, the positional embeddings 306 may be used to define relative positions of different time-series data values 302 in time. This may allow, for instance, the foundation machine learning model 116 to know that certain timestamps used by some time-series data values 302 occurred before or after certain timestamps used by other time-series data values 302. The relative positions may be defined in any suitable manner, such as when the positional embeddings 306 are based on absolute timestamps, relative timestamps, or positional indicators associated with absolute or relative timestamps.

The time-series data values 302 may be combined with the positional embeddings 306 by a combiner 308, which combines the time-series data values 302 and the positional embeddings 306 in order to generate input data 310. The combiner 308 may use any suitable technique(s) to combine the time-series data values 302 and the positional embeddings 306 in order to generate the input data 310. In some cases, for example, the combiner 308 may append the positional embeddings 306 to the time-series data values 302 (or vice versa), such as by performing concatenation.

The textual descriptions 304 are processed using a language embedding model 312, which generally operates to convert the textual descriptions 304 into textual description embeddings 314. The textual description embeddings 314 represent vectors or other representations of the textual descriptions 304 within a defined feature space, and the language embedding model 312 is trained to generate the textual description embeddings 314 in order to represent the textual descriptions 304 within that defined feature space. The language embedding model 312 may use any suitable technique(s) to convert textual descriptions 304 into textual description embeddings 314.

A combiner 316 combines the textual description embeddings 314 with the input data 310 in order to generate combined input data 318. The combiner 316 may use any suitable technique(s) to combine the textual description embeddings 314 and the input data 310 in order to generate combined input data 318. In some cases, for example, the combiner 316 may append the textual description embeddings 314 to the input data 310 (or vice versa), such as by performing concatenation.

The combined input data 318 is provided to an encoder 320, which processes the combined input data 318 and generates embedding vectors 322 representing the combined input data 318. The embedding vectors 322 are representations of the various inputs (including the time-series data values 302 and the textual descriptions 304) within a defined feature space. In some embodiments, the encoder 320 can represent a transformer-based encoder or other machine learning-based encoder that performs transformations on vector representations or other representations in order to extract information from the combined input data 318. As a particular example, the encoder 320 may represent a collection of transformer layers that can collectively perform multiple attention operations and multiple feed-forward operations to extract information from the combined input data 318 and generate the embedding vectors 322.

In some embodiments, the various components 308, 312, 316, 320 shown in FIG. 3 may be referred to as a time-series embedding model 324. The embedding model 324 here can process various inputs (including time-series data 118) and generate corresponding embedding vectors 322 representing those inputs. In various figures described below, one or more instances of the embedding model 324 may be used to generate suitable embedding vectors 322 or other embeddings of time-series data 118, and those embeddings may be used in any suitable manner and for any suitable purpose(s).

In this particular example, the embedding vectors 322 are provided to a decoder 326, which can process the embedding vectors 322 and generate outputs 328. In some embodiments, the decoder 326 can represent a transformer-based decoder or other machine learning-based decoder that performs transformations on embedding vectors 322 in order to generate predictions or other outputs 328. As a particular example, the decoder 326 may represent a collection of transformer layers that can collectively perform multiple attention operations and multiple feed-forward operations to generate predictions based on the embedding vectors 322. The outputs 328 may represent any suitable predictions or other information generated by the decoder 326. For instance, the outputs 328 may represent predictions of future time-series values, possibly along with the textual description embeddings 314 associated with those future time-series values. Note, however, that the specific predictions or other outputs 328 generated by the foundation machine learning model 116 can easily vary depending on the specific application.

Developing foundation models is generally a data-hungry task, meaning very large amounts of data are typically needed (both from a quantity point of view and from a diversity point of view). This is one obstacle for developing foundation models for the sensory or other time-series modality. However, the lack of data for developing time-series foundation models may not be due to the fact that adequate time-series data is unavailable. Rather, the lack of data for developing time-series foundation models can be due to difficulties related to combining different datasets coming from different fields or domains (or even from the same or similar fields or domains) for training purposes. In other words, training of time-series foundation models may involve the use of lots of time-series training data from various fields or domains, and it is difficult to combine time-series training data from different fields or domains or even from the same or similar fields or domains into a coherent dataset for training a time-series foundation model. Moreover, many multi-variate time-series models are sensitive to the ordering of the time-series data used for training. That is, a model trained to process time-series data coming from multiple sources in a particular order can fail (sometimes spectacularly) if the exact same data is processed by the exact same model but in a different order. These issues can prevent the usage of traditional time-series modeling approaches and datasets for creating time-series foundation models.

To help overcome these or other issues, the foundation machine learning model 116 shown in FIGS. 3A and 3B (or at least the time-series embedding model 324 shown in FIG. 3A) supports one or more approaches for combining embeddings from different modalities, so the foundation machine learning model 116 can be said to support a transference approach. The transference approach enables the foundation machine learning model 116 to borrow powerful representations available for one modality to help with developing models or extracting insights for another modality. More specifically, the foundation machine learning model 116 here borrows knowledge from language embeddings to help with the sensory or other time-series modality. This is accomplished by appending or otherwise combining time-series information (represented by the input data 310) with the textual description embeddings 314. This allows the use of textual descriptions of different sensors or other time-series data sources along with powerful language embeddings associated with these textual descriptions.

The architecture of the foundation machine learning model 116 shown in FIGS. 3A and 3B can be trained in any suitable manner. In some embodiments, the language embedding model 312 and the other components of the architecture (like the encoder 320 and decoder 326) can be trained separately. In other embodiments, the language embedding model 312 and the other components of the architecture (like the encoder 320 and decoder 326) can be trained jointly. In particular embodiments, the foundation machine learning model 116 is trained using one or more minimizing cost functions based on randomly-masked data, overall reconstruction, or forecasting. The masking or predictions may include or exclude textual descriptions. If textual information is included in the cost function(s), it may be possible to train the foundation machine learning model 116 to generate sensor descriptions given other sensors and their descriptions. It is also possible to define the cost function(s) to include a contrastive loss associated with the embeddings so that the foundation machine learning model 116 can learn how to generate good one-shot embeddings. In some cases, joint training may prevent the foundation machine learning model 116 from relying on spurious correlations, since learning good discriminative representations can involve exposing more than just correlations. As a result, this can push the foundation machine learning model 116 to uncover some causal properties hidden in data. Either way, all of these training processes may be compatible with proven processes used for training other types of foundation models.

Note that one or more training datasets used to train the foundation machine learning model 116 can include multiple (potentially numerous) time-series datasets from multiple (potentially numerous) fields or domains. The time-series datasets can often include datasets of different sizes and qualities, and the datasets can span varying lengths of time and have varying sampling intervals. Increasing the number and diversity of the time-series datasets during training can help the foundation machine learning model 116 learn how to process and predict time-series data in a wide variety of use cases. Moreover, various permutations in the ordering of the time-series datasets can be used during training to help the foundation machine learning model 116 learn how to process and predict time-series data accurately even in the presence of different data orderings.

Once the foundation machine learning model 116 is trained to generate good internal representations of time-series data 118, the internal representations of the time-series data 118 (the embedding vectors 322) can be used in various ways. One example use is shown in FIGS. 3A and 3B. Other example uses of one or more trained foundation machine learning models 116 are shown in other figures described below. However, one or more trained foundation machine learning models 116 or one or more time-series embedding models 324 may be used in any other suitable manner.

Note that it is possible for the foundation machine learning model 116 or the time-series embedding model 324 to receive and process additional inputs during training and/or inferencing. As a particular example, each training dataset processed during training of the foundation machine learning model 116 or the time-series embedding model 324 may include a natural language description or other description of the dataset itself, which could be processed using the language embedding model 312 or other model and converting into one or more additional textual description embeddings. The additional textual description embedding(s) may be combined with the time-series data values 302, the textual descriptions 304, and optionally the positional embeddings 306 during processing to generate embedding vectors 322. A natural language description or other description of inputs being processed during inferencing could also be used in the same or similar manner to generate embedding vectors 322.

Although FIGS. 3A and 3B illustrate one example of a foundation machine learning model 116 for sensory or other time-series data 118, various changes may be made to FIGS. 3A and 3B. For example, various components or functions in FIGS. 3A and 3B may be combined, further subdivided, replicated, rearranged, or omitted according to particular needs. Also, various additional components or functions may be used in FIGS. 3A and 3B.

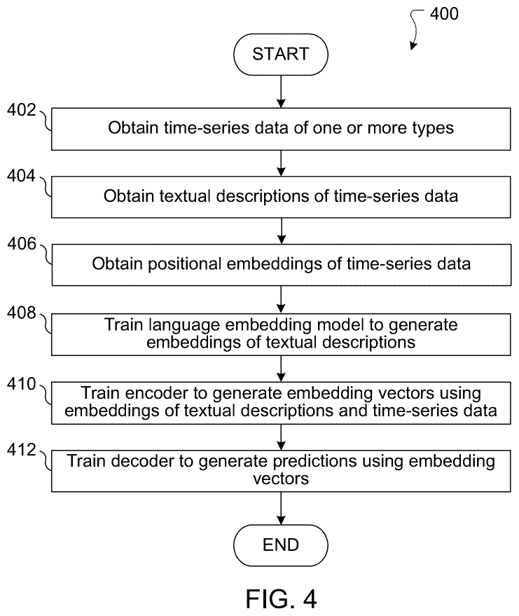

FIG. 4 illustrates an example method 400 for training foundation machine learning models 116 for sensory or other time-series data 118 according to this disclosure. For ease of explanation, the method 400 is described as being used in the system 100 of FIG. 1, such as when the method 400 is performed using the application server 106 (which may be implemented using one or more instances of the device 200 shown in FIG. 2) to train one or more foundation machine learning models 116 (which may be implemented using at least the time-series embedding model 324 and possibly the entire architecture as shown in

FIGS. 3A and 3B). However, the method 400 shown in FIG. 4 may be performed using any suitable device(s) and in any suitable system(s), and the method 400 may be used to train any suitable foundation machine learning models 116 or time-series embedding models 324 designed in accordance with this disclosure.

As shown in FIG. 4, time-series data of one or more types is obtained at step 402, textual descriptions of the time-series data are obtained at step 404, and positional embeddings of the time-series data may optionally be obtained at step 406. This may include, for example, the processing device 202 of the application server 106 obtaining multiple sets of time-series data values 302 or other time-series data 118 to be used to train at least one foundation machine learning model 116. This may also include the processing device 202 of the application server 106 obtaining textual descriptions 304 that describe the different sets of the time-series data values 302. In some cases, this may further include the processing device 202 of the application server 106 obtaining positional embeddings 306 that define relative positions of different time-series data values 302 in time. All or some of this data may be collectively referred to as training data.

As noted above, in some embodiments, the time-series data 118 here may involve a very large number of assets and may include time-series data values 302 associated with various fields or domains and various time periods. For example, different sets of time-series data values 302 may have been collected or otherwise obtained over different lengths of time and/or using different sampling intervals. Also, the training data can be obtained in any suitable manner and from any suitable source(s). In some embodiments, for instance, the training data may be collected by a party training the foundation machine learning model(s) 116 from multiple (potentially numerous) data sources, such as from its own internal operational or other database(s), customers of the party training the foundation machine learning model(s) 116, publicly-available data sources, or proprietary data sources.

A language embedding model is trained to generate embeddings of the textual descriptions of the time-series data at step 408. This may include, for example, the processing device 202 of the application server 106 training the language embedding model 312 to generate textual description embeddings 314 based on the textual descriptions 304. For instance, the language embedding model 312 can be trained to generate the textual description embeddings 314 within a defined feature space.

An encoder is trained to generate embedding vectors using the embeddings of the textual descriptions and the obtained time-series data at step 410. This may include, for example, the processing device 202 of the application server 106 training the encoder 320 to generate embedding vectors 322 based on the time-series data values 302 and the textual description embeddings 314 (and optionally the positional embeddings 306). In some embodiments, the process for training the encoder 320 can use different permutations or combinations of the training data. Among other things, the different permutations or combinations of the time-series data values 302 can include different permutations related to the ordering of the time-series data values 302. This approach can therefore help train the encoder 320 to be less sensitive to the actual ordering of the time-series data values 302, which can be useful since (as described above) a model trained to process time-series data coming from multiple sources in a particular order can fail if the exact same data is processed by the exact same model but in a different order. A decoder may optionally be trained to generate predictions based on the embedding vectors at step 412. This may include, for example, the processing device 202 of the application server 106 training the decoder 326 to generate desired outputs 328 based on the embedding vectors 322.

The training of each foundation machine learning model 116 generally involves learning weights or other parameters of various layers of the foundation machine learning model 116 (such as for different layers of the language embedding model 312, the encoder 320, and optionally the decoder 326) using the training data. The foundation machine learning model 116 processes various training data (such as the time-series data values 302, the textual description embeddings 314, and optionally the positional embeddings 306) to generate embedding vectors 322 or outputs 328. A cost or loss can be calculated based on the generated embedding vectors 322 or outputs 328, such as through comparisons with each other or with expected outputs (ground truths). The calculated cost or loss can be used to update the weights or other parameters of the foundation machine learning model 116 or portions thereof, such as via stochastic gradient descent, back-propagation, or other suitable techniques.

Any suitable cost or loss function may be used during the training of a foundation machine learning model 116. In typical embodiments, a cost or loss minimization function is defined, where changes are made to the weights or other parameters of the foundation machine learning model 116 in an attempt to alter terms of the minimization function and (ideally) minimize the cost or loss of the foundation machine learning model 116 being trained. Various types of cost and loss minimization functions can be defined and used here. In some embodiments, for example, a cost function may include or be based on a contrastive loss associated with embeddings (such as the embedding vectors 322) generated by the foundation machine learning model 116. Contrastive loss generally refers to the distance between positive and negative examples output by a machine learning model, meaning lower loss is measured if similar inputs to the foundation machine learning model 116 result in similar outputs from the foundation machine learning model 116 and if dissimilar inputs to the foundation machine learning model 116 result in dissimilar outputs from the foundation machine learning model 116. The use of contrastive loss may help the foundation machine learning model 116 to effectively learn how to generate high-quality one-shot embeddings or other outputs.

In some cases, the specific cost or loss function(s) used during the training of a foundation machine learning model 116 can be defined based on how the foundation machine learning model 116 is to be used. For example, the training process might involve randomly masking portions of the time-series data 118 so that the foundation machine learning model 116 can be trained to generate replacement time-series data 118 for the masked (hidden but known) portions, and the cost or loss may be determined by comparing generated time-series data 118 with the masked portions of the time-series data 118. The training process might involve providing lower-resolution versions of the time-series data 118 so that the foundation machine learning model 116 can be trained to generate higher-resolution versions of the time-series data 118, and the cost or loss may be determined based on an overall reconstruction loss between the expected and desired outputs of the foundation machine learning model 116. The training process might involve providing some time-series data 118 so that the foundation machine learning model 116 can predict or forecast additional time-series data 118, and the cost or loss may be determined based on a forecasting loss between the expected and desired outputs of the foundation machine learning model 116.

Overall, the training process here trains the at least one foundation machine learning model 116 to process time-series data values 302 of time-series data 118 of different types, textual descriptions 304 of the time-series data 118, and optionally positional embeddings 306 of the time-series data 118 in order to generate embedding vectors 322 or other predictions associated with the time-series data 118. In some embodiments, the at least one foundation machine learning model 116 can be trained by processing large amounts of training data from various fields or domains, which may allow the at least one foundation machine learning model 116 to learn how to generate embedding vectors 322 or other predictions in those fields or domains and to learn associations with data in some fields or domains that might be applicable in other fields or domains to support cross-domain learning. In some cases, this may allow users who have less time-series data 118 (such as due to a lack or sensors) to still use a trained foundation machine learning model 116 since the foundation machine learning model 116 can be trained using large quantities of time-series data 118 (potentially including time-series data 118 from other users).

Among other things, a foundation machine learning model 116 can be trained to use time-series data values 302 and related textual descriptions 304 and optional positional embeddings 306 to learn dependencies or relationships between different sensors (meaning different sources of different sets of time-series data values 302). This allows the foundation machine learning model 116 to learn whether or not to pay attention to certain sensors' time-series data values 302 when asked to generate predictions about other sensors' time-series data values 302. This can also help to provide a degree of interpretability to the predictions made by the foundation machine learning model 116. For instance, when asked to make a prediction regarding one sensor's time-series data values 302, the foundation machine learning model 116 can identify one or more other sensors' time-series data values 302 as justification for its prediction. Interpretability can be very useful when machine learning models are being used since improved interpretability can provide better user insight into how predictions are actually made, thereby increasing the ease of incorporating the predictions into bigger decision-making processes or other processes.

Although FIG. 4 illustrates one example of a method 400 for training foundation machine learning models 116 for sensory or other time-series data 118, various changes may be made to FIG. 4. For example, while shown as a series of steps, various steps in FIG. 4 may overlap, occur in parallel, occur in a different order, or occur any number of times (including zero times). As a particular example, in some embodiments, the language embedding model 312, the encoder 320, and optionally the decoder 326 may be trained separately, such as by training each with its own suitable training data. In other embodiments, the language embedding model 312, the encoder 320, and optionally the decoder 326 may be trained collectively or jointly, such as in an end-to-end manner.

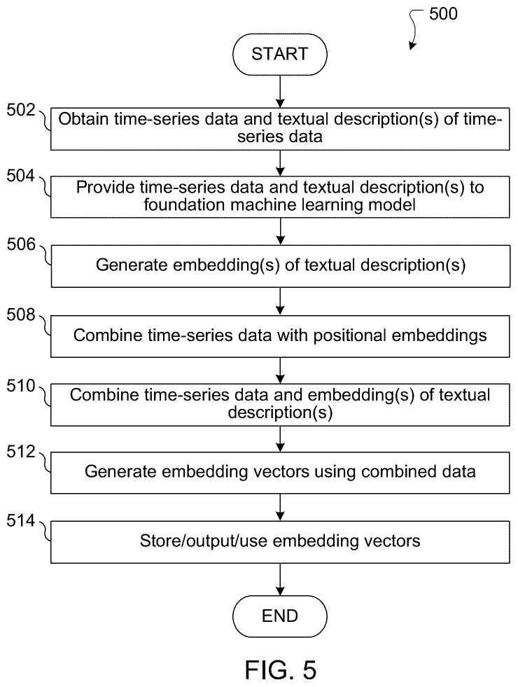

FIG. 5 illustrates an example method 500 for using foundation machine learning models for sensory or other time-series data according to this disclosure. For ease of explanation, the method 500 is described as being used in the system 100 of FIG. 1, such as when the method 500 is performed using the application server 106 (which may be implemented using one or more instances of the device 200 shown in FIG. 2) with one or more foundation machine learning models 116 (which may be implemented using at least the time-series embedding model 324 and possibly the entire architecture as shown in FIGS. 3A and 3B). However, the method 500 shown in FIG. 5 may be performed using any suitable device(s) and in any suitable system(s), and the method 500 may be used with any suitable foundation machine learning models 116 or time-series embedding models 324 designed in accordance with this disclosure.

As shown in FIG. 5, time-series data and one or more textual descriptions of the time-series data are obtained at step 502. This may include, for example, the processing device 202 of the application server 106 receiving time-series data values 302 or other time-series data 118 and textual descriptions 304 of the time-series data 118 from one or more sources. The time-series data and the textual descriptions of the time-series data are provided to a foundation machine learning model (or a time-series embedding model thereof) at step 504. This may include, for example, the processing device 202 of the application server 106 pre-processing the time-series data 118 (such as to provide data cleaning) if needed or desired. The time-series data 118 can be provided as input to the foundation machine learning model 116 or the time-series embedding model 324. One or more textual description embeddings are generated based on the one or more textual descriptions at step 506. This may include, for example, the processing device 202 of the application server 106 using the language embedding model 312 to generate one or more textual description embeddings 314 based on the textual description(s) 304.

The time-series data may optionally be combined with positional embeddings at step 508, and the time-series data is combined with the embedding(s) of the textual description(s) at step 510. This may include, for example, the processing device 202 of the application server 106 combining the time-series data values 302 with the positional embeddings 306 (if available) and with the one or more textual description embeddings 314 that are generated based on the one or more textual descriptions 304. Embedding vectors are generated using the combined data at step 512. This may include, for example, the processing device 202 of the application server 106 using the encoder 320 to generate embedding vectors 322 that represent the combination of the time-series data values 302, the one or more textual description embeddings 314, and optionally the positional embeddings 306 (if available).

The embedding vectors are stored, output, or used in some manner at step 514. The specific manner in which the embedding vectors are used can vary depending on the application in which the foundation machine learning model 116 or the time-series embedding model 324 is being used. In the example of FIGS. 3A and 3B, for instance, the embedding vectors may be processed to generate predictions. This may include, for example, the processing device 202 of the application server 106 using the decoder 326 to process the embedding vectors 322 and generate outputs 328, which may represent one or more predictions associated with the time-series data 118. In other example use cases, one or more historical time points may be identified using the embeddings of the time-series data, such as when the processing device 202 of the application server 106 searches for other embeddings associated with other time-series data that are similar to the embeddings of the current time-series data 118 being processed. Similarity here can be determined in any suitable manner, such as based on having similarity scores above a specified threshold. If one or more historical time points are identified, additional information related to the one or more historical time points may be obtained, such as when the processing device 202 of the application server 106 obtains metadata or other information like operator logs, shift notes, or Internet searches associated with the one or more historical time points. In general, it is possible for any of a wide variety of information to be obtained and used here, such as any of a wide variety of information that is timestamped. This supplemental information can be obtained from one or more external data sources 120 or in any other suitable manner. This provides the potential for incorporating information from various data sources that previously could not be used. Any of the predictions and/or additional information can be stored, output, or used, such as when the predictions and/or additional information is output for use during a decision-making process. In some cases, the additional information may be used as an explanation of an associated prediction, which can help to increase the interpretability of the predictions. Note, however, that the embeddings, predictions, and/or additional information may be used in any other suitable manner.

Although FIG. 5 illustrates one example of a method 500 for using foundation machine learning models 116 for sensory or other time-series data 118, various changes may be made to FIG. 5. For example, while shown as a series of steps, various steps in FIG. 5 may overlap, occur in parallel, occur in a different order, or occur any number of times (including zero times).

As noted above, there are various ways in which foundation machine learning models 116 or time-series embedding models 324 may be used. For example, there are various ways in which the embedding vectors 322 generated by a time-series embedding model 324 may be used to perform other functions. The following now describes example ways in which one or more foundation machine learning models 116 or time-series embedding models 324 may be used. Note, however, that these specific uses are examples only, and foundation machine learning models 116 and time-series embedding models 324 may be used in any other suitable manner.

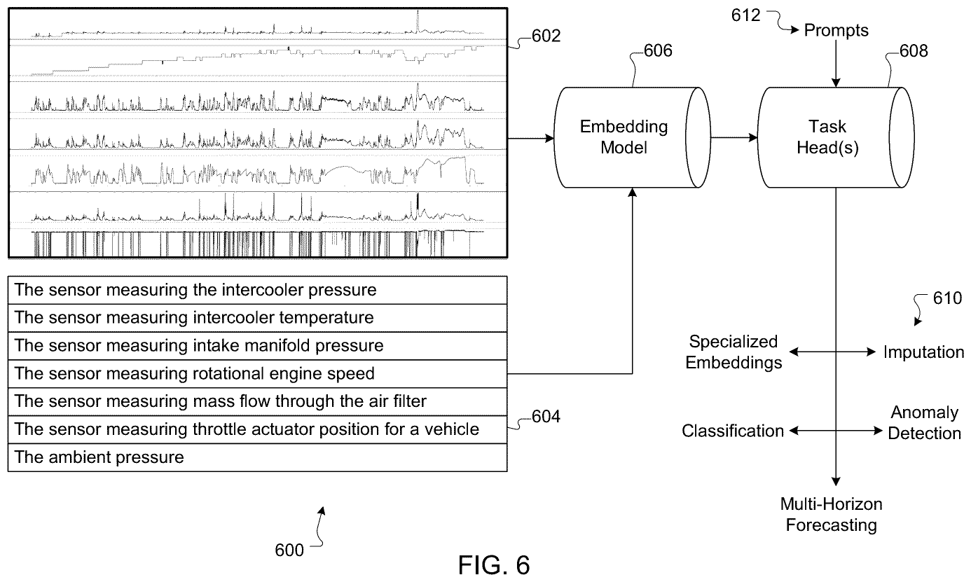

FIGS. 6 through 8 illustrate example pipelines using foundation machine learning models 116 for sensory or other time-series data to support specified functions according to this disclosure. For ease of explanation, each pipeline in FIGS. 6 through 8 is described as being used in the system 100 of FIG. 1, such as when the pipeline is used by the application server 106 (which may be implemented using one or more instances of the device 200 shown in FIG. 2) and includes one or more foundation machine learning models 116 (which may be implemented using at least the time-series embedding model 324 and possibly the entire architecture as shown in FIGS. 3A and 3B). However, each pipeline shown in FIGS. 6 through 8 may be used by or with any suitable device(s) and in any suitable system(s), and each pipeline may include any suitable foundation machine learning models 116 or time-series embedding models 324 designed in accordance with this disclosure.

As shown in FIG. 6, a pipeline 600 receives and processes time-series data values 602 and textual descriptions 604 of the time-series data values 602. The time-series data values 602 and the textual descriptions 604 may be obtained in any suitable manner and from any suitable source(s). The time-series data values 602 may be the same as or similar to the time-series data values 302 described above, and the textual descriptions 604 may be the same as or similar to the textual descriptions 304 described above. In the illustrated embodiment, the time-series data values 602 relate to different sensor measurements associated with an aircraft or other vehicle, and the textual descriptions 604 generally describe what characteristics those different sensor measurements represent. However, this is for illustration and explanation only.

An embedding model 606 can represent an instance of the time-series embedding model 324 described above, and the embedding model 606 can process the time-series data values 602 and the textual descriptions 604 to generate embedding vectors (such as embedding vectors 322). Although not shown here, the embedding model 606 may also receive and process positional embeddings, such as in the same or similar manner described above, when generating the embedding vectors. For example, the embedding model 606 may combine the time-series data values 602 with any positional embeddings, combine the resulting input data with embeddings of the textual descriptions 604, and process the combined data using an encoder.

In this example, the embedding vectors from the embedding model 606 are provided to one or more task heads 608, which may represent at least one multi-task head in some embodiments. Each task head 608 represents at least one machine learning model or other logic that is trained or otherwise configured to perform or initiate performance of one or more tasks 610. Any suitable task or tasks 610 may be performed using the embedding vectors from the embedding model 606. The following provides specific examples of tasks 610 that may be performed using the embedding vectors from the embedding model 606. Note that the number of task heads 608 and the number of tasks 610 can vary depending on the implementation.

In this example, the tasks 610 may include the creation of specialized embeddings, which generally involves creating embedding vectors or other embeddings within a customized or specialized feature space. In some cases, this may be useful when embeddings are needed in a customized or specialized feature space for a specific domain (such as healthcare or finance) or when embeddings otherwise need to be fine-tuned for subsequent use. For example, the embeddings generated by the embedding model 606 can be modified by a machine learning model or other logic implementing the tasks 610 in order to create the specialized embeddings.

The tasks 610 may also include the performance of classification, which generally involves determining how the time-series data values 602 represented by the embedding vectors from the embedding model 606 should be classified into one of various classifications. For example, the classification process may involve determining how different parts of the time-series data values 602 should be classified into different ones of various classifications. The classifications can easily vary based on the use case. For instance, time-series data values 602 related to industrial or other equipment could be classified into classifications such as normal operation and abnormal operation.

The tasks 610 may further include the performance of multi-horizon forecasting, which generally involves processing the time-series data values 602 in order to estimate how one or more characteristics of the time-series data values 602 may vary in the future. For example, the multi-horizon forecasting process may involve analyzing the time-series data values 602 in order to determine how one or more variables captured in the time-series data values 602 are expected to vary in the future given historical and current time-series data values 602. Note that forecasting over a single horizon is also possible using the time-series data values 602.

The tasks 610 may also include the performance of anomaly detection, which generally involves processing the time-series data values 602 in order to identify anomalous or unexpected/unexplained variations in the time-series data values 602 over time. For example, the anomaly detection process may involve analyzing the time-series data values 602 in order to predict how variables captured in the time-series data values 602 are expected to vary in the future (possibly based on the multi-horizon forecasting process) and identifying when any of the variables varies more or less than expected.

In addition, the tasks 610 may include the performance of imputation, which generally involves identifying a cause or source of an anomaly or other issue with one or more time-series data values 602. For example, the imputation process may involve analyzing the time-series data values 602 in order to identify anomalous behaviors (possibly based on the anomaly detection process) of one or more variables captured in the time-series data values 602 and identify potential causes or sources of the anomalous behaviors.

Note that each of these tasks 610 can be performed in any number of ways. For example, various techniques have been developed for generating specialized embeddings, performing classification, performing multi-horizon forecasting, performing anomaly detection, and performing imputation. Also, additional techniques are sure to be developed in the future. Any of these techniques that operate using embedding vectors or other embeddings of time-series data can be performed using the embedding model 606 and the approaches described above.

In some embodiments, one or more of the tasks 610 may be performed using or based on prompts 612, which can represent natural language inputs or other inputs that invoke the one or more tasks 610 and/or provide guidance or instruction for performing the one or more tasks 610. For example, prompts 612 could identify a specific domain for which specialized embeddings are to be generated, identify potential classes or groupings for classification, identify a time period for which multi-horizon forecasting is to be performed, identify a time period for which anomaly detection is to be performed, or identify a specific time period for which imputation is to be performed. Each prompt 612 may be obtained from any suitable source and may have any suitable format.

Also, in some embodiments, the embedding model 606 may be trained using multi-domain unsupervised learning, which can involve the use of training data from multiple fields or domains (and potentially numerous fields or domains) and training via at least one unsupervised learning technique. Further, in some embodiments, the one or more task heads 608 may be trained using multi-domain supervised fine-tuning, which can involve training each task head 608 to perform a desired function or functions for a specific field or domain based on expected embeddings to be generated using the embedding model 606. In other cases, the one or more task heads 608 may be trained using one-shot learning. In whatever manner the one or more task heads 608 are trained, this approach allows the embeddings generated by the embedding model 606 to be taken and used to perform different functions in different fields or domains, rather than trying to generate an embedding model 606 for each field or domain. Often times, fine-tuning of the results from the embedding model 606 for use with specific fields or domains can be performed faster, as well as more easily and inexpensively, in order to expand the use of the embedding model 606 to different tasks 610 in one or more domains.

As can be seen here, in order to train the overall pipeline 600, some embodiments may use a two-stage training process. In the first training stage, the embedding model 606 may be trained, such as by using the techniques described above. In the second training stage, each of the one or more task heads 608 can be trained to provide the desired fine-tuning for its associated task(s) 610. The specific technique(s) for training the task head(s) 608 can vary depending on the specific task head(s) 608 being trained and the associated task(s) 610 to be performed using the task head(s) 608. Note that there is no requirement here for all task heads 608 to be trained at the same time, and it is possible to train or retrain different task heads 608 at different points in time as needed or desired.

The ability to separately train the embedding model 606 and the task head(s) 608 may (at least in some cases) provide better performance from each of these components. This approach also provides multiple ways of steering the results generated by the overall pipeline 600 during inferencing. For instance, the textual descriptions 604 used by the embedding model 606 and the prompts 612 used by the one or more task heads 608 can both be used, supplemented, revised, or replaced to help guide the operation of the overall pipeline 600 in the performance of the task(s) 610. In addition, this approach may help to simplify and speed up model development with respect to the task head(s) 608 since there may be little or no need to perform time-consuming feature engineering and data cleaning operations. Rather, each task head 608 can be designed to process embedding vectors from the embedding model 606, which can simplify its deployment and improve scalability.

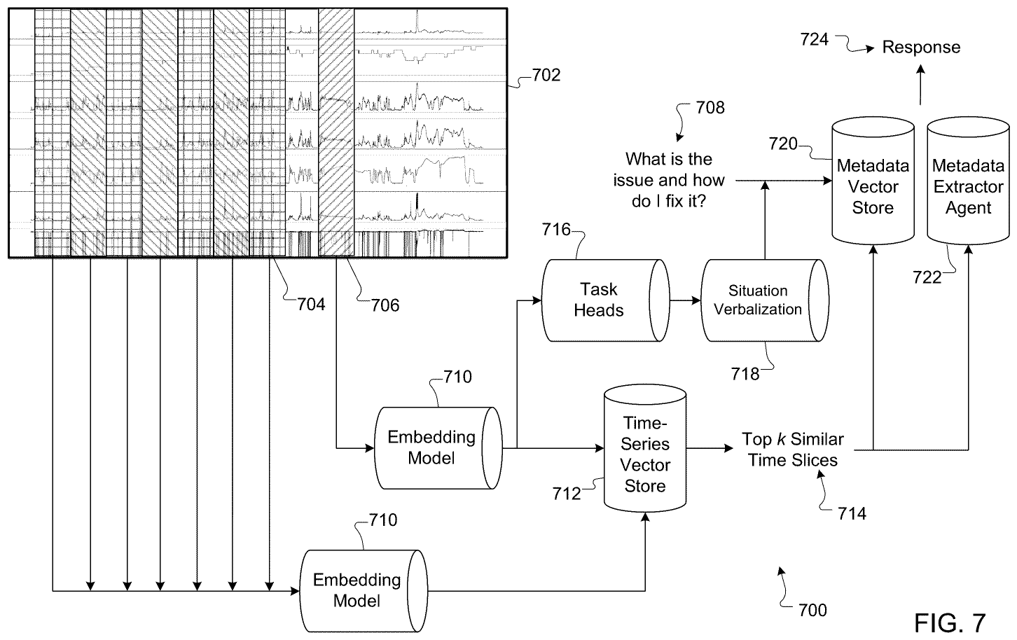

As shown in FIG. 7, a pipeline 700 receives and processes time-series data values 702 along with textual descriptions (not shown). The time-series data values 702 may be the same as or similar to the time-series data values 302, 602 described above, and the textual descriptions may be the same as or similar to the textual descriptions 304, 604 described above. Although not shown here, positional embeddings may also be received and processed, such as in the same or similar manner described above, when generating the embedding vectors.

The time-series data values 702 may be divided into various time slices, each of which represents or includes time-series data values 702 within a specified window or period of time. In this example, six previous time slices 704 have been defined, as well as one time slice 706 that is the subject of a user query 708. For instance, a user may define the time slice 706 as containing anomalous data values or as representing the most-recent time slice, and the user may submit the user query 708 along with an identification of the bounds of the time slice 706. Each of the time slices 704 may represent periods of time defined by the user or by an overall system, such as based on the size of the time slice 706 or based on one or more settings of the overall system.

In this example, each time slice 704 is processed using an embedding model 710, which can represent an instance of the time-series embedding model 324 and can process the time-series data values 702 within that time slice 704. The embedding model 710 can also process the associated textual descriptions of the time-series data values 702 within that time slice 704 and optionally process any associated positional embeddings. Embedding vectors for the time-series data values 702 within these time slices 704 can be generated and stored, such as in a time-series vector store 712 or other database or storage. In some cases, the embedding vectors for the time-series data values 702 within the time slices 704 may be generated and stored ahead of time, meaning prior to receiving the user query 708. In other cases, the embedding vectors for the time-series data values 702 within the time slices 704 may be generated based on the user query 708 and stored for potential subsequent use.

When the user query 708 is received and the time slice 706 is identified, the time-series data values 702 within that time slice 706 can be processed using the embedding model 710 again. The embedding model 710 can also process the associated textual descriptions of the time-series data values 702 within that time slice 706 and optionally process any associated positional embeddings. The embedding vectors for the time-series data values 702 within the time slice 706 can be used to access the time-series vector store 712 and generate an identification 714 of the top k similar time slices. Here, the “top k” similar time slices represent an identification of the k time slices 704 that are most similar to the time slice 706 based on their embedding vectors (where k≥1). Any suitable measure of similarity may be used to identify which of the embedding vectors associated with the time slices 704 are most similar to the embedding vectors associated with the time slice 706, such as cosine similarity.

The embedding vectors for the time slice 706 can also be provided to one or more task heads 716, which can generate outputs that are processed using a situation verbalization model 718. The task head(s) 716 and the situation verbalization model 718 can be used to generate text or other data describing what appears to be occurring with the time-series data values 702 within the time slice 706. In some cases, this can be based on textual embeddings of textual descriptions of the time-series data values 702, which (as noted above) are not shown here but can have the same or similar format and content as described above. Thus, for instance, the task head(s) 716 may identify rises, falls, oscillations, or other unexpected behavior(s) of time-series data from one or more sensors as contained with the time-series data values 702, and the situation verbalization model 718 may generate text describing the identified behavior(s).

The user query 708, the identification 714 of the top k similar time slices, and the generated description of what is occurring in the time slice 706 are provided to a metadata vector store 720 and a metadata extractor agent 722, which can process the inputs (possibly along with one or more additional inputs) in order to generate a response 724 to the user query 708. In some embodiments, the metadata vector store 720 can store metadata associated with the time-series data values 702 in the time slices 704 or other time-series data, such as metadata that explains what occurred during the previous time slices 704. The metadata vector store 720 can therefore be used to identify one or more potential reasons why the time-series data values 702 in the time slice 706 are diverging or otherwise behaving as they are and one or more potential solutions to that behavior. The metadata extractor agent 722 can be used to extract data, such as by extracting time-series data values 702 from one or more of the time slices 704 (possibly the most relevant time slice or slices 704), which may be used as justification for the potential reason(s) and the potential solution(s). The metadata extractor agent 722 may also or alternatively identify other supplemental information (such as operator logs, shift notes, Internet searches, etc.) that may be used to obtain additional information regarding the time slice 706 or the most relevant time slice or slices 704. In some cases, the response 724 thereby identify why the time-series data values 702 in the time slice 706 behaved as they did and what might be done to remedy this.

As a particular example of how this functionality might be used, as described above, one use of time-series data involves multi-horizon or other forecasting in which estimates of what future time-series data values might be are generated based on current and historical time-series data values. Here, it may be determined that time-series data values 702 actually received from one or more sensors are diverging from forecasted time-series data values for the sensor(s). A user or a larger system may identify the time slice 706 as containing the diverging time-series data values 702, and the pipeline 700 may be used to identify one or more potential causes for the divergence and one or more potential solution to the potential cause(s). The response 724 may include an identification of one or more previous time slices 704 in which the same or similar behavior was observed or an identification of one or more previous time slices 704 that are determined to have caused the divergence. This type of pipeline may be said to support a post hoc approach for interpretability. That is, it may be assumed here that there is a causal relationship between what occurs in the time slice 706 and what occurs in one or more of the previous time slices 704. Note, however, that any other suitable approaches may be supported to provide interpretability in the pipeline 700 or in other pipelines.

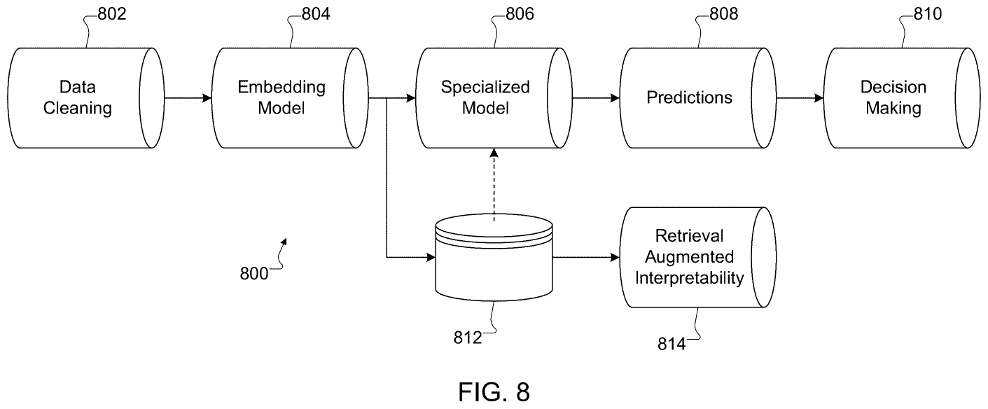

As shown in FIG. 8, time-series data to be processed by a pipeline 800 can be received and pre-processed during a data cleaning operation 802. The data cleaning operation 802 may include one or more functions that help to clean up the time-series data to be processed by the pipeline 800, such as by filtering the time-series data, interpolating or otherwise filling in missing time-series data, or removing outliers in the time-series data. The pre-processed time-series data is provided to an embedding model 804, which generally operates to convert the pre-processed time-series data into embedding vectors. The embedding model 804 can represent an instance of the time-series embedding model 324.

The embedding vectors are provided to a specialized model 806, which generally operates to process the embedding vectors to generate predictions 808. The contents of the predictions 808 can easily vary based on the use case. Thus, the design and operation of the specialized model 806 can vary based on the use case. During a training process, the specialized model 806 can be trained to generate accurate predictions 808, which can be used in any suitable manner. In some cases, the specialized model 806 generates predictions 808 to be provided to one or more end users, who can use the predictions 808 to make decisions. In some embodiments, the pipeline 800 can use the specialized model 806 to produce predictions 808 that can be used directly as part of a decision-making process 810, and the pipeline 800 can support an architecture that promotes transparency and understanding of how these predictions 808 have been created (thereby providing model-level interpretability).

Since the foundation machine learning model 116 or time-series embedding model 324 (used as the embedding model 804) is a foundation model that can be applicable across multiple and potentially numerous use cases, the foundation machine learning model 116 or time-series embedding model 324 may be very complex. As a result, it may not be possible to rely on classical post hoc interpretability techniques to generate insights or other explanations as to why the foundation machine learning model 116 or time-series embedding model 324 makes various predictions 808.

In order to address this issue, the pipeline 800 can use the embedding model 804 to generate embedding vectors for some or all of historical time-series data received by the pipeline 800 in a vector store 812. For new time-series data, a retrieval-augmented interpretability operation 814 can use the embedding vectors of the new time-series data to search the vector store 812 for the same or similar embedding vectors associated with other time points in the historical time-series data. Time points where similar situations have occurred in the past can be identified based on the associated historical time-series data having embedding vectors with similarity scores above a specified threshold, meaning those time points in the past have embedding vectors that match or are close to the embedding vectors of the new time-series data. In some cases, the similarity search may be defined by the contrastive loss used during training.

Once one or more time points are identified, any metadata or other supplemental information (such as operator logs, shift notes, Internet searches, etc.) can be identified by the retrieval-augmented interpretability operation 814 and provided for use during the decision-making process 810. This metadata or other supplemental information can be obtained from one or more external data sources 120 or in any other suitable manner. In some embodiments, information related to the one or more retrieved time points may also be provided to the specialized model 806 for use in generating predictions 808. For instance, a prediction 808 may be based on a state of current time-series data and one or more states in the historical time-series data associated with the one or more retrieved time points, such as when the prediction 808 is based on a majority vote, weighted majority vote, average state, or weighted average state of the state of the current time-series data and the one or more states in the historical time-series data.

This approach to interpretability can provide a more natural way of generating insights for end users and may remove the need for subject matter experts or other personnel to create and recreate heuristics to assist with interpretability. Note that the metadata or other additional information associated with each timepoint may be of different modalities, which allows the pipeline 800 to represent a multi-modal pipeline. This can be achieved through so-called “coordination” of the different modalities. It is also possible to combine the different modalities in more direct ways, such as through fusion approaches, and generate insights without the need for conducting a vector search.

The approaches shown in FIGS. 7 and 8 also enable the identification of novel regimes when similar past cases with similarity scores above a certain threshold cannot be located, in which case a subject matter expert or other personnel may be engaged as needed or desired. Once such cases are identified and personnel feedback is incorporated, such regimes can be readily detectable and their corresponding insights can be leveraged in the future without the need for any retraining. These approaches therefore support a version of continual learning. In cases where an embedding model might become stale and/or require re-tuning (such as based on feedback from users and subject matter experts or other personnel), existing processes like reinforcement learning from human feedback (RLHF) or direct preference optimization (DPO) may be used for tuning the embedding model with direct feedback and without the need for any specialized data processing for different use cases.

Although FIGS. 6 through 8 illustrate examples of pipelines using foundation machine learning models 116 for sensory or other time-series data to support specified functions, various changes may be made to FIGS. 6 through 8. For example, various components or functions in each of FIGS. 6 through 8 may be combined, further subdivided, replicated, rearranged, or omitted according to particular needs. Also, various additional components or functions may be used in each of FIGS. 6 through 8. In addition, components in different ones of FIGS. 6 through 8 may be combined into a single pipeline, such as when the data cleaning operation 802 or the retrieval-augmented interpretability operation 814 (or other components used to support interpretability) are used in the pipeline 600 or 700 of FIG. 6 or 7.

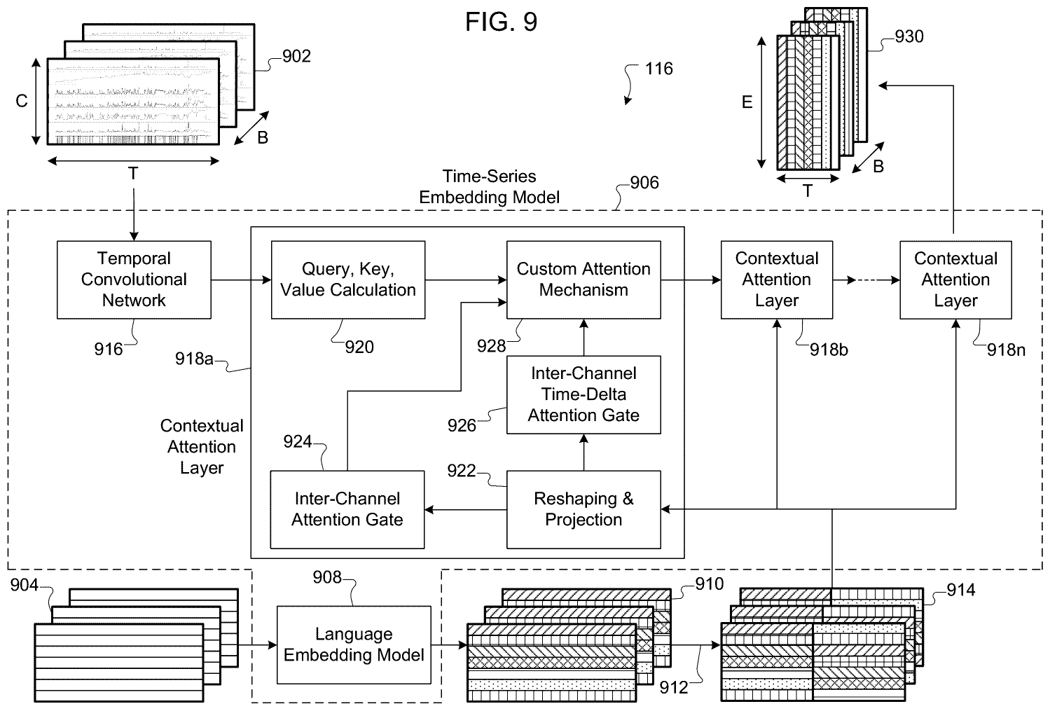

FIG. 9 illustrates another example foundation machine learning model 116 for sensory or other time-series data according to this disclosure. For ease of explanation, the foundation machine learning model 116 shown in FIG. 9 is described as being used in the system 100 of FIG. 1, such as when the foundation machine learning model 116 is trained and/or used by the application server 106 (which may be implemented using one or more instances of the device 200 shown in FIG. 2). However, the foundation machine learning model 116 shown in FIG. 9 may be used by or with any suitable device(s) and in any suitable system(s). The foundation machine learning model 116 shown in FIG. 9 may also be used in any suitable pipelines or other larger architectures, including those described above.

As shown in FIG. 9, the foundation machine learning model 116 receives and processes time-series data values 902 and textual descriptions 904 of the time-series data values 902. The time-series data values 902 and the textual descriptions 904 may be obtained in any suitable manner and from any suitable source(s). The time-series data values 902 may be the same as or similar to the time-series data values 302, 602, 702 described above, and the textual descriptions 904 may be the same as or similar to the textual descriptions 304, 604 described above. Although not shown here, positional embeddings may also be received and processed, such as in the same or similar manner described above. In this example, the time-series data values 902 can be contained in multiple sets, where T represents time, C represents the number of sensors providing the time-series data values 902 in each set, and B represents the number of sets. Similarly, there can be multiple sets of textual descriptions 904, where each set of textual descriptions 904 contains descriptions of the time-series data values 902 in a corresponding one of the sets of time-series data values 902.

The time-series data values 902 and the textual descriptions 904 are processed using a time-series embedding model 906. The time-series embedding model 906 includes a language embedding model 908, which generally operates to convert the textual descriptions 904 into textual description embeddings 910. The textual description embeddings 910 represent vectors or other representations of the textual descriptions 904 within a defined feature space, and the language embedding model 908 is trained to generate the textual description embeddings 910 in order to represent the textual descriptions 904 within that defined feature space. The language embedding model 908 may use any suitable technique(s) to convert textual descriptions 904 into textual description embeddings 910. In this example, a mixing process 912 can also be used to generate mixed textual description embeddings 914, which represent different permutations or combinations of the textual description embeddings 910. The mixing process 912 can use any suitable technique(s) to create different permutations or combinations of the textual description embeddings 910.

The time-series embedding model 906 also includes a temporal convolutional network 916 and a collection of context attention layers 918a-918n. The temporal convolutional network 916 generally represents a set of causal convolutional layers that can apply a specified kernel to the time-series data values 902, where outputs from the temporal convolutional network 916 have the same size (length) as inputs to the temporal convolutional network 916. The specified kernel can be used here to convolve the time-series data values 902, where time-series data at any given time may be convolved only with time-series data prior to that given time. The outputs of the temporal convolutional network 916 represent a modeled version of the sequential (time-series) data contained in the time-series data values 902.

Each of the context attention layers 918a-918n may have the form shown in FIG. 9 for the context attention layer 918a. In this example, the context attention layer 918a includes a query, key, and value calculation operation 920, which generally operates to process the modeled version of the time-series data generated by the temporal convolutional network 916 in order to generate query (Q), key (K), and value (V) matrices based on the time-series data. In some embodiments, for instance, the query, key, and value matrices can be generated by multiplying the modeled version of the time-series data by learnable matrices, which represent matrices generated during training of the foundation machine learning model 116. A reshaping and projection operation 922 can be used to reshape and project the mixed textual description embeddings 914 into a space suitable for use with the query, key, and value matrices. For instance, the query, key, and value matrices typically have dimensions that are different than the dimensions of the mixed textual description embeddings 914. The reshaping and projection operation 922 can therefore operate to convert the mixed textual description embeddings 914 into suitable corresponding dimensions, such as dimensions corresponding to the dimensions of the query, key, and value matrices.

An inter-channel attention gate 924 is trained to make predictions across different channels, meaning across different sensors. For example, each context attention layer 918a-918n may be associated with a different sensor. Each instance of the inter-channel attention gate 924 can be trained to determine, for an associated sensor, which other sensor or sensors appear relevant to the associated sensor. Relevance here can be defined as the other sensor(s) appearing to have an impact on the time-series data values 902 produced by the associated sensor or appearing to have a similar behavior as the time-series data values 902 produced by the associated sensor. Thus, for instance, there may be one hundred sensors, but the inter-channel attention gate 924 may learn that only a subset of sensors, such as four sensors, are relevant to the time-series data values 902 produced by the associated sensor. This allows the inter-channel attention gate 924 to give higher weight or pay more attention to the time-series data values 902 produced by that subset of sensors when the context attention layer 918a is making predictions for the associated sensor. This approach thereby allows the foundation machine learning model 116 to be trained to identify, for any given sensor, which other sensor or sensors might be useful in generating predictions for the given sensor.

An inter-channel time-delta attention gate 926 is trained to make predictions across time for different channels. For example, each instance of the inter-channel time-delta attention gate 926 can be trained to determine, for a given sensor at a given time or time period, which other previous or subsequent time periods appear relevant to the given sensor's time-series data values 902 at the given time or time period. Again, relevance here can be defined as the time period(s) appearing to have an impact on the time-series data values 902 produced by the given sensor or appearing to have a similar behavior as the time-series data values 902 produced by the given sensor. Thus, for instance, the inter-channel time-delta attention gate 926 may determine that one or more time periods (such as time slices) before a given time or time period and/or one or more time periods (such as time slices) after the given time or time period appear to impact the time-series data values 902 produced by the associated sensor. This allows the inter-channel time-delta attention gate 926 to give higher weight or pay more attention to the time-series data values 902 produced within the identified time slice(s) or other time period(s) when the context attention layer 918a is making predictions for the associated sensor. This approach thereby allows the foundation machine learning model 116 to be trained to identify, for any given sensor, which other time periods might be useful in generating predictions for the given sensor.

Outputs from the inter-channel attention gate 924 and the inter-channel time-delta attention gate 926 are provided to a custom attention mechanism 928, which can also receive the query, key, and value matrices generated by the query, key, and value calculation operation 920. Classical attention mechanisms generally process the query, key, and value matrices in order to generate predictions. In the foundation machine learning model 116 of FIG. 9, the custom attention mechanism 928 can use a similar approach to process the query, key, and value matrices, but the custom attention mechanism 928 can be guided by the inter-channel attention gate 924 and the inter-channel time-delta attention gate 926. In other words, the custom attention mechanism 928 can use the outputs from the inter-channel attention gate 924 and the inter-channel time-delta attention gate 926 to determine which other sensor(s) and which time period(s) should receive more or less attention while processing the query, key, and value matrices.

The time-series embedding model 906 shown here can process the time-series data values 902, the textual descriptions 904, and optionally any positional embeddings in order to generate outputs 930. The outputs 930 can represent embedding vectors or other suitable embeddings or other representations of predictions that are associated with or based on the time-series data values 902. As shown in FIG. 9, the actual dimensions of the outputs 930 can differ from the dimensions of the time-series data values 902.

This approach can provide for more effective use of attention-based tools since the foundation machine learning model 116 can learn specifically which other sensor(s) and time period(s) may have an impact on any given sensor. Moreover, this approach can provide model-level interpretability since the foundation machine learning model 116 can identify the other sensor(s) and time period(s) that may have an impact on any given sensor. This information can be used to provide a justification for one or more predictions generated by the foundation machine learning model 116. For instance, when asked to make a prediction involving a particular sensor, the foundation machine learning model 116 may identify the other sensor(s) and time period(s) determined to be relevant, thereby providing some level of justification or explainability for the prediction involving the particular sensor. Note that the foundation machine learning model 116 here may be trained to perform various functions or be incorporated into one or more pipelines that perform various functions (such as any of the pipelines described above). In some cases, the foundation machine learning model 116 shown in FIG. 9 may be used to facilitate performance of one or more of the tasks 610.

One factor that can affect the interpretability or explainability of the outputs 930 generated by the foundation machine learning model 116 is sparsity. That is, the foundation machine learning model 116 can be trained to identify sensors and time periods that affect its predictions. Training the foundation machine learning model 116 using one or more adequately-large datasets can provide the foundation machine learning model 116 with the ability to identify a relatively small number of sensors and/or a relatively small number of time periods that are relevant to any given sensor from among a larger number of sensors and/or time periods. Thus, for example, the number of relevant sensors can be sparse given the total number of sensors. This sparsity in terms of sensors and/or time periods may make it easier for the outputs 930 to be explained, since the foundation machine learning model 116 may generate a prediction based on time-series data values 902 from a relatively small number of sensors and/or time periods. This can be particularly useful in various multi-variate applications, where it is often difficult to discern one sensor's behavior in the context of numerous other sensors' behaviors.

There are various ways in which this type of functionality may be used. For example, a foundation machine learning model 116 may be trained using data from or associated with a very large number of assets in the same asset class, including data from or associated with multiple configurations of the same type of asset. As a particular example, the foundation machine learning model 116 may be trained to generate predictions regarding the operation or state of pumps, and the foundation machine learning model 116 may be trained using time-series data from or associated with hundreds or thousands of pumps having different manufacturers, sensor locations, types of sensors, etc. The foundation machine learning model 116 can be trained using this time-series data, and the textual descriptions of the time-series data and optionally the positional embeddings of the time-series data can be used to help unify the time-series data used during training. When a new asset (such as a new pump) becomes available, it may be possible for the foundation machine learning model 116 to generate predictions for the new asset, even though the foundation machine learning model 116 was not previously trained using training data for that new asset. Thus, if a new pump becomes available, the foundation machine learning model 116 may determine which of the hundreds or thousands of pumps for which time-series data was used during training are associated with time-series data that appears similar to the time-series data for the new pump. In other words, the foundation machine learning model 116 may determine which of the hundreds or thousands of pumps for which time-series data was used during training should receive more attention.

As another example, some assets may have very long operational lifespans, such as when airplanes, helicopters, or other aircraft are expected to be in use for many years (potentially decades or more). Each aircraft typically has sensors of various numbers, types, and locations. During an aircraft's operational lifespan, newer aircraft of the same asset class can typically become available. Time-series data associated with a large number of aircraft of at least one asset class may be used to train a foundation machine learning model 116, such as a foundation machine learning model 116 used (by itself or as part of a larger pipeline) to generate reliability or maintenance predictions associated with aircraft. The foundation machine learning model 116 can be trained using this time-series data, and the textual descriptions of the time-series data and optionally the positional embeddings of the time-series data can be used to help unify the time-series data used during training. When a new model of aircraft (such as a new airplane or helicopter) becomes available, it may be possible for the foundation machine learning model 116 to generate predictions for the new aircraft, even though the foundation machine learning model 116 was not previously trained using training data for that new aircraft. This can be achieved even if the new aircraft includes other or additional sensors since the textual descriptions of the various sensors can be used by the foundation machine learning model 116 to process time-series data for the new aircraft.

Although FIG. 9 illustrates another example of a foundation machine learning model 116 for sensory or other time-series data, various changes may be made to FIG. 9. For example, various components or functions in FIG. 9 may be combined, further subdivided, replicated, rearranged, or omitted according to particular needs. Also, various additional components or functions may be used in FIG. 9.

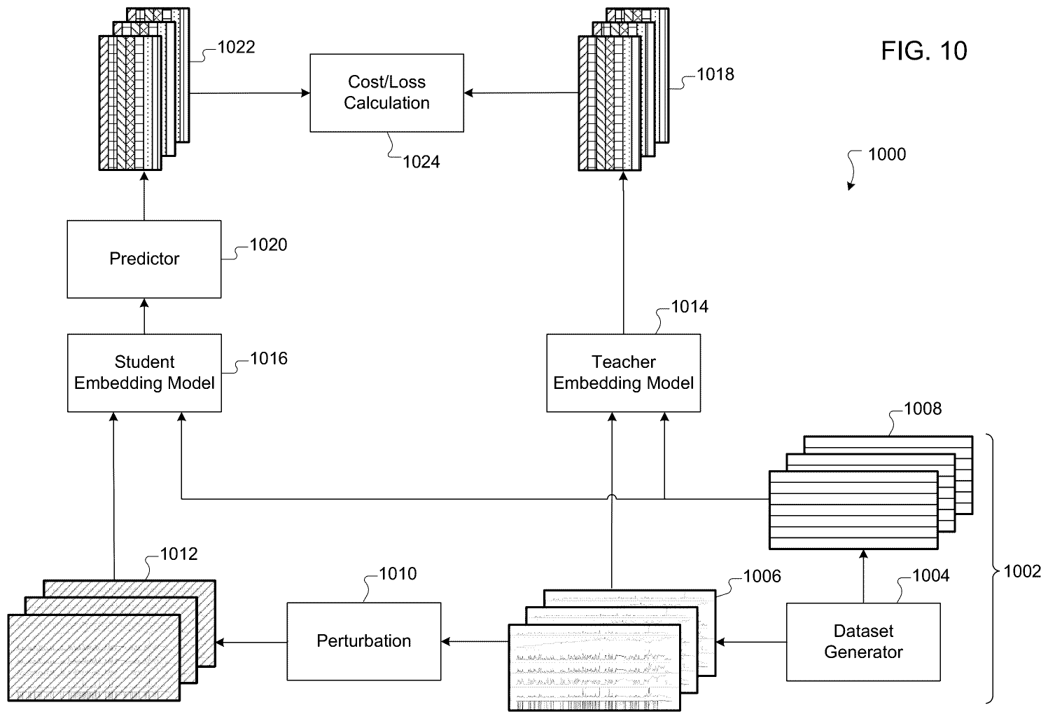

FIG. 10 illustrates an example training process 1000 for the foundation machine learning model 116 for sensory or other time-series data of FIG. 9 according to this disclosure. In this particular example, the training process 1000 in FIG. 10 can be said to support a Joint Embedding Predictive Architecture (JEPA) training approach. As shown in FIG. 10, the training process 1000 includes a training dataset generation process 1002, which generally operates to produce one or more training datasets for use in the training process 1000. In this example, the training dataset generation process 1002 can generate or otherwise obtain various sets of time-series data values 1006 and various sets of textual descriptions 1008 associated with the sets of time-series data values 1006. The time-series data values 1006 and the textual descriptions 1008 may be obtained in any suitable manner and from any suitable source(s). In some embodiments, for instance, the time-series data values 1006 may be associated with actual equipment or other assets being monitored, and the textual descriptions 1008 may be generated based at least in part on user input.

The time-series data values 1006 are modified using a perturbation process 1010, which generally operates to perturb or otherwise modify the time-series data values 1006 in order to generate modified time-series data values 1012. In some embodiments, the perturbation process 1010 can corrupt the time-series data values 1006 in one or more ways that are often seen in reality. For instance, the perturbation process 1010 may corrupt the time-series data values 1006 by randomly dropping values (thereby creating missing values) and/or by randomly increasing or decreasing individual time-series data values 1006 or groups of time-series data values 1006 (thereby creating outlier values). Any other or additional modifications may be made to the time-series data values 1006 here by the perturbation process 1010 in order to generate the modified time-series data values 1012.

As noted above, the training process 1000 supports the use of a Joint Embedding Predictive Architecture training approach, which includes the use of a teacher embedding model 1014 and a student embedding model 1016. The embedding models 1014, 1016 can share a common machine learning architecture, such as the architecture shown in FIG. 9. The teacher embedding model 1014 can be used to process the time-series data values 1006 and generate embeddings 1018 based on the time-series data values 1006. The student embedding model 1016 can be used to process the modified time-series data values 1012 and generate embeddings based on the modified time-series data values 1012 (which represent a corrupted version of the time-series data values 1006). A predictor operation 1020 is trained to process the embeddings generated by the student embedding model 1016 and estimate embeddings 1022 representing the time-series data values 1006 (without corruption) based on the embeddings generated by the student embedding model 1016. For example, the predictor operation 1020 can be trained to generate the embeddings 1022 by learning various transformations or other operations that are used to modify the embeddings generated by the student embedding model 1016 (which are based on corrupted time-series data) in order to produce embeddings 1022 that should (in theory) more closely match or align with the embeddings 1018 generated by the teacher embedding model 1014.

A cost or loss calculation operation 1024 can identify the cost or loss associated with the student embedding model 1016 based on the embeddings 1018, 1022. Note that the cost or loss can be generated based on any number of iterations of the teacher and student embedding models 1014, 1016. Based on the calculated cost or loss, weights of the student embedding model 1016 can be updated, such as by using stochastic gradient descent, back-propagation, or other suitable techniques. In contrast, the teacher embedding model 1014 may be updated more slowly, such as when the weights of the teacher embedding model 1014 are updated based on exponential moving averages or other averages of the weights of the student embedding model 1016. This allows the embeddings 1018 generated by the teacher embedding model 1014 to be more stable over time relative to the embeddings 1022.

The overall effect of the training process 1000 here is that the teacher and student embedding models 1014, 1016 are updated over time in a generally self-supervised manner. The cost or loss function that is used by the cost or loss calculation operation 1024 here can be based on or guided by the architecture of the embedding models 1014, 1016 and the type(s) of embeddings to be generated using the embedding models 1014, 1016. In some cases, the cost or loss function that is used by the cost or loss calculation operation 1024 may include or be based on contrastive loss. During this training process, the inter-channel attention gate 924 and the inter-channel time-delta attention gate 926 of each context attention layer 918a-918n can be trained to learn the (typically sparse) associations of sensors and time periods. Once trained, the foundation machine learning model 116 may be placed into use, such as within a pipeline or other larger architecture (including those described above).

Although FIG. 10 illustrates one example of a training process 1000 for the foundation machine learning model 116 for sensory or other time-series data of FIG. 9, various changes may be made to FIG. 10. For example, the training process 1000 of FIG. 10 illustrates one example of a type of training approach that could be used to train the foundation machine learning model 116 of FIG. 9. However, the foundation machine learning model 116 of FIG. 9 could be trained using any other suitable training process.

The foundation machine learning models 116 and pipelines described above may be used in a wide variety of use cases in which time-series data and related textual descriptions are processed to generate discriminative embedding vectors. The embedding vectors may be used by the foundation machine learning models 116 themselves or by other machine learning models or other functions. The following describes specific examples of use cases in which this functionality may be used. However, the foundation machine learning models 116 and the pipelines may each be used in any other suitable manner.

As one particular example, time-series data may identify various health-related information of a user, such as heart rate, blood pressure, pulse shape, and so on, over time. The user may determine at some point that he or she does not “feel normal,” at which point current time-series data of the user may be processed by a foundation machine learning model 116. The foundation machine learning model 116 may determine, based on past information, that the user is likely becoming ill, which is a prediction that could be used by the user to help mitigate a current illness or avoid infecting others.

As another particular example, time-series data may identify various characteristics related to a vehicle, pump or other industrial equipment, or other asset. A foundation machine learning model 116 may process this time-series data in order to estimate the current state of the asset's health, perform root cause analysis of an asset failure, or perform forecasting to estimate a future state of the asset's health.

As another particular example, time-series data may identify various characteristics related to one or more securities or stock markets. A foundation machine learning model 116 may process this time-series data in order to estimate a future state of the one or more securities or stock markets or to identify actions of more successful securities traders. In some cases, this analysis may be combined with additional data obtained from one or more external data sources 120, such as one or more earnings reports or other information associated with an individual security or a stock market as a whole.

In these and other various use cases, it is possible to train a single foundation machine learning model 116 to analyze different types of time-series data and make predictions based on the different types of time-series data. This is because the textual descriptions can help the foundation machine learning model 116 to determine how different types of time-series data should be analyzed when generating predictions or other outputs. As a particular example of this, a foundation machine learning model 116 may be used to analyze data for various assets including pumps. This analysis can be done on an individual basis for each pump, but the foundation machine learning model 116 itself may be trained using time-series data for numerous assets (including assets unrelated to pumps). In some cases, this may allow the foundation machine learning model 116 to identify one or more specific conditions associated with a first type of asset based on training data for the same or similar condition(s) associated with a second type of asset, even if there is little or no training data available for the specific condition(s) associated with the first type of asset.

There are also various ways in which historical time-series data may be used by a foundation machine learning model 116. For example, the historical time-series data may be grouped into overlapping chunks of data, such as when the historical time-series data is grouped into overlapping five-hour periods or other time periods. Embeddings for the chunks of historical time-series data may be generated, stored in a vector store or other storage, and used to identify any similarities with current time-series data. It is also possible to group the historical time-series data into chunks of various lengths of time, such as when the historical time-series data is grouped into overlapping chunks of 30 minutes, overlapping chunks of 60 minutes, overlapping chunks of 90 minutes, or overlapping chunks of other time scales. In some cases, the vector store or other storage may be indexed using these time scales so that embeddings for chunks of appropriate lengths can be identified and used.

It should be noted that the functions shown in or described with respect to FIGS. 1 through 10 can be implemented in a server or other electronic device(s) in any suitable manner. For example, in some embodiments, at least some of the functions shown in or described with respect to FIGS. 1 through 10 can be implemented or supported using one or more software applications or other software instructions that are executed by the processing device(s) 202 of the application server 106 or other electronic device(s). In other embodiments, at least some of the functions shown in or described with respect to FIGS. 1 through 10 can be implemented or supported using dedicated hardware components. In general, the functions shown in or described with respect to FIGS. 1 through 10 can be performed using any suitable hardware or any suitable combination of hardware and software/firmware instructions. Also, the functions shown in or described with respect to FIGS. 1 through 10 can be performed by a single electronic device or by multiple electronic devices.

The following clauses describe example embodiments of this disclosure. However, other embodiments may be used in accordance with the teachings of this disclosure.

Clause 1: A method comprising:
obtaining time-series data of at least one type and at least one textual description of the at least one type of time-series data; and
processing the time-series data and the at least one textual description using a foundation machine learning model;
wherein processing the time-series data and the at least one textual description using the foundation machine learning model comprises:
   generating at least one embedding of the at least one textual description;
   combining the time-series data and the at least one embedding of the at least one textual description to generate combined data; and
   generating embedding vectors using the combined data.

Clause 2: The method of Clause 1, wherein:
combining the time-series data and the at least one embedding of the at least one textual description comprises combining the time-series data, the at least one embedding of the at least one textual description, and at least one positional embedding to generate the combined data; and
the at least one positional embedding defines relative positions of different data values of the time-series data in time.

Clause 3: The method of Clause 2, wherein combining the time-series data, the at least one embedding of the at least one textual description, and the at least one positional embedding comprises concatenating the time-series data, the at least one embedding of the at least one textual description, and the at least one positional embedding.

Clause 4: The method of any of Clauses 1 through 3, further comprising:
generating a prediction associated with the time-series data using the embedding vectors.

Clause 5: The method of Clause 4, wherein:
the embedding vectors are generated using an encoder of the foundation machine learning model; and
the prediction is generated using a decoder.

Clause 6: The method of any of Clauses 1 through 5, further comprising:
using the embedding vectors to identify at least one time point associated with historical time-series data; and
obtaining additional information associated with the at least one time point.

Clause 7: The method of any of Clauses 1 through 6, wherein generating the at least one embedding of the at least one textual description comprises:
generating the at least one embedding of the at least one textual description using a language embedding model of the foundation machine learning model.

Clause 8: The method of any of Clauses 1 through 7, wherein:
the time-series data relates to a specified asset in a specified asset class; and
the foundation machine learning model is trained using training data associated with the specified asset class but not training data associated with the specified asset.

Clause 9: The method of any of Clauses 1 through 8, further comprising:
providing the embedding vectors to at least one task head; and
performing one or more tasks using the at least one task head.

Clause 10: The method of Clause 9, wherein the one or more tasks comprise at least one of: generation of specialized embeddings, classification, forecasting, anomaly detection, or imputation.

Clause 11: The method of any of Clauses 1 through 10, wherein:
the time-series data is divided into multiple time slices including a specified time slice and additional time slices;
embedding vectors are generated for each of the time slices; and
the method further comprises:
   identifying one or more of the additional time slices that are most similar to the specified time slice based on the embedding vectors;
   obtaining a user query associated with the specified time slice; and
   generating a response to the user query based on the one or more additional time slices that are most similar to the specified time slice.

Clause 12: The method of Clause 11, wherein:
the specified time slice is associated with a time period during which values of the time-series data were previously predicted;
the user query is related to a divergence of actual values of the time-series data from predicted values of the time-series data within the specified time slice; and
the response identifies at least one explanation for the divergence based on the one or more additional time slices that are most similar to the specified time slice.

Clause 13: The method of any of Clauses 1 through 12, wherein combining the time-series data and the at least one embedding of the at least one textual description comprises using different permutations in ordering the time-series data.

Clause 14: A method comprising:
training a foundation machine learning model to process time-series data of at least one type and textual descriptions of the time-series data and generate embedding vectors associated with the time-series data;
wherein training the foundation machine learning model comprises:
   training a language embedding model to generate embeddings of the textual descriptions of the time-series data; and
   training an encoder to generate the embedding vectors using combinations of the time-series data and the embeddings of the textual descriptions.

Clause 15: The method of Clause 14, wherein:
the encoder is trained to generate the embedding vectors using combinations of the embeddings of the textual descriptions, the embeddings of the time-series data, and at least one positional embedding; and
the at least one positional embedding defines relative positions of different data values of the time-series data in time.

Clause 16: The method of Clause 15, wherein the foundation machine learning model concatenates the time-series data, the embeddings of the textual descriptions, and the at least one positional embedding.

Clause 17: The method of any of Clauses 14 through 16, further comprising:
training the foundation machine learning model or another model to generate a prediction associated with the time-series data using the embedding vectors.

Clause 18: The method of Clauses 14 through 17, wherein:
the time-series data represents training data related to multiple assets in a specified asset class; and
the foundation machine learning model is trained to generate embedding vectors for additional time-series data associated with a specified asset, the training data lacking data for the specified asset.

Clause 19: The method of any of Clauses 14 through 18, further comprising:
training at least one task head to perform one or more tasks using the embedding vectors.

Clause 20: The method of Clause 19, wherein the one or more tasks comprise at least one of: generation of specialized embeddings, classification, forecasting, anomaly detection, or imputation.

Clause 21: The method of any of Clauses 14 through 20, wherein training the foundation machine learning model comprises using different permutations in an order of the time-series data.

Clause 22: The method of any of Clauses 14 through 21, further comprising:
training a decoder to generate predictions using the embedding vectors.

Clause 23: The method of any of Clauses 14 through 22, wherein training the foundation machine learning model comprises using a contrastive loss associated with the embeddings of the time-series data.

Clause 24: A method comprising:
providing time-series data of at least one type and at least one textual description of the at least one type of time-series data to a foundation machine learning model; and
receiving a prediction based on embedding vectors generated by the foundation machine learning model using the time-series data and the at least one textual description;
wherein the foundation machine learning model is configured to process the time-series data and the at least one textual description by:
   generating at least one embedding of the at least one textual description;
   combining the time-series data and the at least one embedding of the at least one textual description to generate combined data; and
   generating the embedding vectors using the combined data.

Clause 25: The method of Clause 24, further comprising:
identifying at least one positional embedding to the foundation machine learning model;
wherein the at least one positional embedding defines relative positions of different data values of the time-series data in time.

Clause 26: The method of Clause 24 or 25, wherein the prediction associated with the time-series data is generated by the foundation machine learning model based on the embedding vectors.

Clause 27: The method of any of Clauses 24 through 26, wherein the prediction is received from a second machine learning model, the second machine learning model configured to generate the prediction based on the embedding vectors.

Clause 28: The method of any of Clauses 24 through 27, wherein:
the time-series data relates to a specified asset in a specified asset class; and
the foundation machine learning model is trained using training data associated with the specified asset class but not training data associated with the specified asset.

Clause 29: The method of any of Clauses 24 through 28, wherein:
the time-series data is divided into multiple time slices including a specified time slice and additional time slices;
the foundation machine learning model is configured to generate embedding vectors for each of the time slices; and
the method further comprises:
   providing a user query associated with the specified time slice; and
   receiving a response to the user query based on one or more additional time slices that are most similar to the specified time slice based on the embedding vectors.

Clause 30: The method of Clause 29, wherein:
the specified time slice is associated with a time period during which values of the time-series data were previously predicted;
the user query is related to a divergence of actual values of the time-series data from predicted values of the time-series data within the specified time slice; and
the response identifies at least one explanation for the divergence based on the one or more additional time slices that are most similar to the specified time slice.

Clause 31: A method comprising:
obtaining time-series data associated with multiple sensors and multiple textual descriptions of the time-series data; and
processing the time-series data and the textual descriptions using a foundation machine learning model;
wherein processing the time-series data and the textual descriptions using the foundation machine learning model comprises:
   generating textual embeddings of the textual descriptions;
   modeling the time-series data using a temporal convolutional network; and
   processing the modeled time-series data and the textual embeddings of the textual descriptions using multiple contextual attention layers, each contextual attention layer configured to selectively provide controllable attention across different ones of the sensors and across different times or time periods.

Clause 32: The method of Clause 31, further comprising:
mixing the textual embeddings of the textual descriptions to generate mixed textual description embeddings;
wherein processing the modeled time-series data and the textual embeddings comprises processing the modeled time-series data and the mixed textual description embeddings.

Clause 33: The method of Clause 32, wherein at least one of the contextual attention layers is configured to:
generate query, key, and value matrices based on the modeled time-series data; and
reshape and project the mixed textual description embeddings based on dimensions of the query, key, and value matrices.

Clause 34: The method of any of Clauses 31 through 33, wherein each of the contextual attention layers is trained to:
determine how to provide, for a specified one of the sensors, more or less attention to one or more other sensors during the processing the time-series data and the textual descriptions; and
determine how to provide, for the specified one of the sensors at a given time or time period, more or less attention to one or more other time periods during the processing the time-series data and the textual descriptions.

Clause 35: The method of Clause 34, wherein each of the contextual attention layers is trained to process query, key, and value matrices while providing attention based on the determinations how to provide more or less attention in order to provide the controllable attention across the different ones of the sensors and across the different times or time periods. Clause 36: The method of any of Clauses 31 through 35, further comprising:
generating a prediction using the foundation machine learning model based on the time-series data and the textual descriptions.

Clause 37: The method of any of Clauses 31 through 36, further comprising:
using the foundation machine learning model to identify at least one time point associated with historical time-series data; and
obtaining additional information associated with the at least one time point.

Clause 38: The method of any of Clauses 31 through 37, wherein:
the time-series data relates to a specified asset in a specified asset class; and
the foundation machine learning model is trained using training data associated with the specified asset class but not training data associated with the specified asset.

Clause 39: The method of any of Clauses 31 through 38, further comprising:
providing embedding vectors from the foundation machine learning model to at least one task head; and
performing one or more tasks using the at least one task head.

Clause 40: The method of Clause 39, wherein the one or more tasks comprise at least one of: generation of specialized embeddings, classification, forecasting, anomaly detection, or imputation.

Clause 41: The method of any of Clauses 31 through 40, wherein:
the time-series data is divided into multiple time slices including a specified time slice and additional time slices; and
the method further comprises:
   identifying one or more of the additional time slices that are most similar to the specified time slice;
   obtaining a user query associated with the specified time slice; and
   generating a response to the user query based on the one or more additional time slices that are most similar to the specified time slice.

Clause 42: The method of Clause 41, wherein:
the specified time slice is associated with a time period during which values of the time-series data were previously predicted;
the user query is related to a divergence of actual values of the time-series data from predicted values of the time-series data within the specified time slice; and
the response identifies at least one explanation for the divergence based on the one or more additional time slices that are most similar to the specified time slice.

Clause 43: A method comprising:
training a foundation machine learning model to process time-series data associated with multiple sensors and multiple textual descriptions of the time-series data;
wherein training the foundation machine learning model comprises:
   obtaining a training dataset comprising training time-series data and training textual descriptions of the training time-series data;
   perturbing the training time-series data to generate corrupted training time-series data;
   generating first outputs based on the training time-series data and the training textual descriptions using a teacher machine learning model;
   generating second outputs based on the corrupted training time-series data and the training textual descriptions using a student machine learning model; and
   adjusting weights of the teacher machine learning model and weights of the student machine learning model based on the first and second outputs, wherein the weights of the student machine learning model are adjusted in a different manner than the weights of the teacher machine learning model;
wherein the student machine learning model represents the foundation machine learning model being trained.

Clause 44: The method of Clause 43, wherein:
the weights of the student machine learning model are adjusted based on the first and second outputs; and
the weights of the teacher machine learning model are calculated as exponential moving averages of the weights of the student embedding model.

Clause 45: The method of Clause 43 or 44, wherein perturbing the training time-series data to generate the corrupted training time-series data comprises randomly creating missing values and outlier values in the training time-series data.

Clause 46: The method of any of Clauses 43 through 45, further comprising:
training the foundation machine learning model or another model to generate a prediction using embedding vectors generated by the student machine learning model.

Clause 47: The method of any of Clauses 43 through 46, wherein:
the training time-series data is related to multiple assets in a specified asset class; and
the foundation machine learning model is trained to generate embedding vectors for additional time-series data associated with a specified asset, the training time-series data lacking data for the specified asset.

Clause 48: The method of any of Clauses 43 through 47, further comprising:
training at least one task head to perform one or more tasks using embedding vectors generated by the student machine learning model.

Clause 49: The method of Clause 48, wherein the one or more tasks comprise at least one of: generation of specialized embeddings, classification, forecasting, anomaly detection, or imputation.

Clause 50: The method of any of Clauses 43 through 49, wherein training the foundation machine learning model comprises:
generating textual embeddings of the training textual descriptions; and
mixing the textual embeddings of the textual descriptions to generate mixed textual description embeddings.

Clause 51: The method of any of Clauses 43 through 50, wherein training the foundation machine learning model comprises using a contrastive loss associated with the first and second outputs.

Clause 52: A method comprising:
providing time-series data associated with multiple sensors and at least one textual description of the time-series data to a foundation machine learning model; and
receiving a prediction based on at least one output generated by the foundation machine learning model using the time-series data and the at least one textual description;
wherein the foundation machine learning model is configured to process the time-series data and the at least one textual description by:
   generating textual embeddings of the textual descriptions;
   modeling the time-series data using a temporal convolutional network; and
   processing the modeled time-series data and the textual embeddings of the textual descriptions using multiple contextual attention layers, each contextual attention layer configured to selectively provide controllable attention across different ones of the sensors and across different times or time periods.

Clause 53: The method of Clause 52, wherein:
the foundation machine learning model is further configured to process the time-series data and the at least one textual description by mixing the textual embeddings of the textual descriptions to generate mixed textual description embeddings; and
the foundation machine learning model is configured to process the modeled time-series data and the mixed textual description embeddings.

Clause 54: The method of Clause 53, wherein at least one of the contextual attention layers is configured to:
generate query, key, and value matrices based on the modeled time-series data; and
reshape and project the mixed textual description embeddings based on dimensions of the query, key, and value matrices.

Clause 55: The method of any of Clauses 52 through 54, wherein each of the contextual attention layers is trained to:
determine how to provide, for a specified one of the sensors, more or less attention to one or more other sensors during the processing the time-series data and the textual descriptions; and
determine how to provide, for the specified one of the sensors at a given time or time period, more or less attention to one or more other time periods during the processing the time-series data and the textual descriptions.

Clause 56: The method of Clause 55, wherein each of the contextual attention layers is trained to process query, key, and value matrices while providing attention based on the determinations how to provide more or less attention in order to provide the controllable attention across the different ones of the sensors and across the different times or time periods.

Clause 57: The method of any of Clauses 52 through 56, wherein the prediction is received from a second machine learning model, the second machine learning model configured to generate the prediction based on embedding vectors generated by the foundation machine learning model.

Clause 58: The method of any of Clauses 52 through 57, wherein:
the time-series data relates to a specified asset in a specified asset class; and
the foundation machine learning model is trained using training data associated with the specified asset class but not training data associated with the specified asset.

Clause 59: The method of any of Clauses 52 through 58, wherein:
the time-series data is divided into multiple time slices including a specified time slice and additional time slices;
the foundation machine learning model is configured to generate embedding vectors for each of the time slices; and
the method further comprises:
   providing a user query associated with the specified time slice; and
   receiving a response to the user query based on one or more additional time slices that are most similar to the specified time slice based on the embedding vectors.

Clause 60: The method of Clause 59, wherein:
the specified time slice is associated with a time period during which values of the time-series data were previously predicted;
the user query is related to a divergence of actual values of the time-series data from predicted values of the time-series data within the specified time slice; and
the response identifies at least one explanation for the divergence based on the one or more additional time slices that are most similar to the specified time slice.

Clause 61: An apparatus comprising:
at least one processing device configured to perform the method of any of Clauses 1through 60.

Clause 62: A non-transitory machine readable medium containing instructions that when executed cause at least one processor to perform the method of any of Clauses 1 through 60.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrases “at least one of” and “one or more of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 104 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 104 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining time-series data of at least one type and at least one textual description of the at least one type of time-series data; and
processing the time-series data and the at least one textual description using a foundation machine learning model;
wherein processing the time-series data and the at least one textual description using the foundation machine learning model comprises:
generating at least one embedding of the at least one textual description;
combining the time-series data and the at least one embedding of the at least one textual description to generate combined data; and
generating embedding vectors using the combined data.

2. The method of claim 1, wherein:
combining the time-series data and the at least one embedding of the at least one textual description comprises combining the time-series data, the at least one embedding of the at least one textual description, and at least one positional embedding to generate the combined data; and
the at least one positional embedding defines relative positions of different data values of the time-series data in time.

3. The method of claim 1, further comprising:
generating a prediction associated with the time-series data using the embedding vectors.

4. The method of claim 3, wherein:
the embedding vectors are generated using an encoder of the foundation machine learning model; and
the prediction is generated using a decoder.

5. The method of claim 1, wherein:
the time-series data relates to a specified asset in a specified asset class; and
the foundation machine learning model is trained using training data associated with the specified asset class but not training data associated with the specified asset.

6. The method of claim 1, wherein:
the time-series data is divided into multiple time slices including a specified time slice and additional time slices;
embedding vectors are generated for each of the time slices; and
the method further comprises:
identifying one or more of the additional time slices that are most similar to the specified time slice based on the embedding vectors;
obtaining a user query associated with the specified time slice; and
generating a response to the user query based on the one or more additional time slices that are most similar to the specified time slice.

7. The method of claim 6, wherein:
the specified time slice is associated with a time period during which values of the time-series data were previously predicted;
the user query is related to a divergence of actual values of the time-series data from predicted values of the time-series data within the specified time slice; and
the response identifies at least one explanation for the divergence based on the one or more additional time slices that are most similar to the specified time slice.

8. The method of claim 1, wherein combining the time-series data and the at least one embedding of the at least one textual description comprises using different permutations in ordering the time-series data.

9. A method comprising:
training a foundation machine learning model to process time-series data of at least one type and textual descriptions of the time-series data and generate embedding vectors associated with the time-series data;
wherein training the foundation machine learning model comprises:
training a language embedding model to generate embeddings of the textual descriptions of the time-series data; and
training an encoder to generate the embedding vectors using combinations of the time-series data and the embeddings of the textual descriptions.

10. The method of claim 9, wherein:
the encoder is trained to generate the embedding vectors using combinations of the embeddings of the textual descriptions, the embeddings of the time-series data, and at least one positional embedding; and
the at least one positional embedding defines relative positions of different data values of the time-series data in time.

11. The method of claim 9, further comprising:
training at least one task head to perform one or more tasks using the embedding vectors.

12. The method of claim 9, wherein training the foundation machine learning model comprises using a contrastive loss associated with the embeddings of the time-series data.

13. A method comprising:
providing time-series data of at least one type and at least one textual description of the at least one type of time-series data to a foundation machine learning model; and
receiving a prediction based on embedding vectors generated by the foundation machine learning model using the time-series data and the at least one textual description;
wherein the foundation machine learning model is configured to process the time-series data and the at least one textual description by:
generating at least one embedding of the at least one textual description;
combining the time-series data and the at least one embedding of the at least one textual description to generate combined data; and
generating the embedding vectors using the combined data.

14. The method of claim 13, further comprising:
identifying at least one positional embedding to the foundation machine learning model;
wherein the at least one positional embedding defines relative positions of different data values of the time-series data in time.

15. The method of claim 13, wherein:
the time-series data relates to a specified asset in a specified asset class; and
the foundation machine learning model is trained using training data associated with the specified asset class but not training data associated with the specified asset.

16. The method of claim 13, wherein:
the time-series data is divided into multiple time slices including a specified time slice and additional time slices;
the foundation machine learning model is configured to generate embedding vectors for each of the time slices; and
the method further comprises:
providing a user query associated with the specified time slice; and
receiving a response to the user query based on one or more additional time slices that are most similar to the specified time slice based on the embedding vectors.

17. A method comprising:
obtaining time-series data associated with multiple sensors and multiple textual descriptions of the time-series data; and
processing the time-series data and the textual descriptions using a foundation machine learning model;
wherein processing the time-series data and the textual descriptions using the foundation machine learning model comprises:
generating textual embeddings of the textual descriptions;
modeling the time-series data using a temporal convolutional network; and
processing the modeled time-series data and the textual embeddings of the textual descriptions using multiple contextual attention layers, each contextual attention layer configured to selectively provide controllable attention across different ones of the sensors and across different times or time periods.

18. The method of claim 17, further comprising:
mixing the textual embeddings of the textual descriptions to generate mixed textual description embeddings;
wherein processing the modeled time-series data and the textual embeddings comprises processing the modeled time-series data and the mixed textual description embeddings.

19. The method of claim 18, wherein at least one of the contextual attention layers is configured to:
generate query, key, and value matrices based on the modeled time-series data; and
reshape and project the mixed textual description embeddings based on dimensions of the query, key, and value matrices.

20. The method of claim 17, wherein each of the contextual attention layers is trained to:
determine how to provide, for a specified one of the sensors, more or less attention to one or more other sensors during the processing the time-series data and the textual descriptions; and
determine how to provide, for the specified one of the sensors at a given time or time period, more or less attention to one or more other time periods during the processing the time-series data and the textual descriptions.

21. The method of claim 20, wherein each of the contextual attention layers is trained to process query, key, and value matrices while providing attention based on the determinations how to provide more or less attention in order to provide the controllable attention across the different ones of the sensors and across the different times or time periods.

22. The method of claim 17, further comprising:
providing embedding vectors from the foundation machine learning model to at least one task head; and
performing one or more tasks using the at least one task head.

23. The method of claim 17, wherein:
the time-series data is divided into multiple time slices including a specified time slice and additional time slices; and
the method further comprises:
identifying one or more of the additional time slices that are most similar to the specified time slice;
obtaining a user query associated with the specified time slice; and
generating a response to the user query based on the one or more additional time slices that are most similar to the specified time slice.

24. The method of claim 23, wherein:
the specified time slice is associated with a time period during which values of the time-series data were previously predicted;
the user query is related to a divergence of actual values of the time-series data from predicted values of the time-series data within the specified time slice; and
the response identifies at least one explanation for the divergence based on the one or more additional time slices that are most similar to the specified time slice.

25. A method comprising:
training a foundation machine learning model to process time-series data associated with multiple sensors and multiple textual descriptions of the time-series data;
wherein training the foundation machine learning model comprises:
obtaining a training dataset comprising training time-series data and training textual descriptions of the training time-series data;
perturbing the training time-series data to generate corrupted training time-series data;
generating first outputs based on the training time-series data and the training textual descriptions using a teacher machine learning model;
generating second outputs based on the corrupted training time-series data and the training textual descriptions using a student machine learning model; and
adjusting weights of the teacher machine learning model and weights of the student machine learning model based on the first and second outputs, wherein the weights of the student machine learning model are adjusted in a different manner than the weights of the teacher machine learning model;
wherein the student machine learning model represents the foundation machine learning model being trained.

26. The method of claim 25, wherein:
the weights of the student machine learning model are adjusted based on the first and second outputs; and
the weights of the teacher machine learning model are calculated as exponential moving averages of the weights of the student embedding model.

27. The method of claim 25, wherein perturbing the training time-series data to generate the corrupted training time-series data comprises randomly creating missing values and outlier values in the training time-series data.

28. The method of claim 25, further comprising:
training the foundation machine learning model or another model to generate a prediction using embedding vectors generated by the student machine learning model.

29. The method of claim 25, wherein:
the training time-series data is related to multiple assets in a specified asset class; and
the foundation machine learning model is trained to generate embedding vectors for additional time-series data associated with a specified asset, the training time-series data lacking data for the specified asset.

30. The method of claim 25, wherein training the foundation machine learning model comprises:
generating textual embeddings of the training textual descriptions; and
mixing the textual embeddings of the textual descriptions to generate mixed textual description embeddings.

31. A method comprising:
providing time-series data associated with multiple sensors and at least one textual description of the time-series data to a foundation machine learning model; and
receiving a prediction based on at least one output generated by the foundation machine learning model using the time-series data and the at least one textual description;
wherein the foundation machine learning model is configured to process the time-series data and the at least one textual description by:
generating textual embeddings of the textual descriptions;
modeling the time-series data using a temporal convolutional network; and
processing the modeled time-series data and the textual embeddings of the textual descriptions using multiple contextual attention layers, each contextual attention layer configured to selectively provide controllable attention across different ones of the sensors and across different times or time periods.

32. The method of claim 31, wherein:
the foundation machine learning model is further configured to process the time-series data and the at least one textual description by mixing the textual embeddings of the textual descriptions to generate mixed textual description embeddings; and
the foundation machine learning model is configured to process the modeled time-series data and the mixed textual description embeddings.

33. The method of claim 32, wherein at least one of the contextual attention layers is configured to:
generate query, key, and value matrices based on the modeled time-series data; and
reshape and project the mixed textual description embeddings based on dimensions of the query, key, and value matrices.

34. The method of claim 31, wherein each of the contextual attention layers is trained to:
determine how to provide, for a specified one of the sensors, more or less attention to one or more other sensors during the processing the time-series data and the textual descriptions; and
determine how to provide, for the specified one of the sensors at a given time or time period, more or less attention to one or more other time periods during the processing the time-series data and the textual descriptions.

35. The method of claim 34, wherein each of the contextual attention layers is trained to process query, key, and value matrices while providing attention based on the determinations how to provide more or less attention in order to provide the controllable attention across the different ones of the sensors and across the different times or time periods.
